(19) United States
(12) Patent Application Publication
(10) Pub. No.: US 2011/0078174 A1
(43) Pub. Date: Mar. 31, 2011

(54) SYSTEMS AND METHODS FOR SCHEDULING RECORDINGS USING CROSS-PLATFORM DATA SOURCES

(75) Inventors: Christopher Lee, Lansdowne, PA (US); William L. Thomas, Malvern, PA (US)

(73) Assignee: Rovi Technologies Corporation, Santa Clara, CA (US)

(21) Appl. No.: 12/571,383

(22) Filed: Sep. 30, 2009

(51) Int. Cl. H04N 5/445; G06F 17/30; G06F 3/048; H04N 5/91

(52) U.S. Cl. 707/769; 715/780; 725/51; 386/E05.003

(57) ABSTRACT

Systems and methods are provided for scheduling media asset actions (e.g., media asset reminders, media asset recordings, etc.) on media assets, based on a user's list of favored artists (e.g., actor/actress, band, celebrity, etc.). A system that obtains a list of artists that are favored by a user is provided. Information is obtained from a website, where the obtained information indicates that one of the artists in the list is scheduled to perform during a particular time. Based on the obtained information, a media asset action is scheduled for the identified media asset.

### BACKGROUND

This application relates to interactive media guidance applications and more particularly to scheduling media asset actions (e.g., reminders for media assets, recordings for media assets, etc.).

Traditional systems automatically record suggested television programs by allowing a user to rate programs he/she has viewed, find programs that may be of interest to the user from a media guidance application database, and automatically record those programs.

The traditional systems, however, record programs based on a user's general interest with a television program, and not based on a user's specific interest of an artist. For example, a user may rate “How I Met Your Mother” with three thumbs up, and the traditional system may record “Friends” based on the fact that both shows are watched by a similar demographic. The traditional systems may have failed to realize that the user rates “How I Met Your Mother” highly because of the user's particular interest in Neil Patrick Harris (an actor on the television program).

Moreover, the traditional systems record the entire television program, while the user may only be interested in a segment of the television program in which the artist appears (e.g., Neil Patrick Harris appearing for an interview on The Jay Leno Show).

In certain cases, the media guidance application data from cable or satellite television providers is deficient. For instance, last minute schedule changes is not reflected in the schedule data in the schedule data. For example, breaking news segment that mentions Michael Jackson's death on the Today Show may not be reflected in the schedule data. In some instances, the program descriptions are not sufficiently granular to reflect all the details regarding the content of the show. For example, a cameo appearance on an episode of The Sopranos may not be described in the program description of the episode.

### SUMMARY OF THE INVENTION

In view of the foregoing, it would be desirable to provide systems and method for scheduling media asset actions (e.g., media asset reminders, media asset recordings, etc.) on media assets, based on a user's list of favored artists (e.g., actor/actress, band, celebrity, company employee etc.). In particular, it would be desirable to provide a system that obtains a list of artists that are favored by a user. Information is obtained from a website, where the obtained information indicates that one of the artists in the list is scheduled to perform during a particular time. In some embodiments, the information about the performance may be received from third-party websites hosted on a third-party web server. The information may be received via a defined application programming interface (API). In certain embodiments, the information about the performance is obtained by extracting information about the performance by parsing the textual data on a webpage of the website. In some embodiments, the website embeds schedule and/or non schedule information on the website by embedding the information in a format that a defined application programming interface is configured to accept. Based on the obtained information, a media asset action is scheduled for the identified media asset.

Based on the obtained information, a media asset associated with the scheduled performance of the artist is identified. The system then schedules for recording the identified media asset. In alternative embodiments, other media asset actions, such as scheduling a program reminder, may be performed on the identified media asset. As defined herein the term “media asset actions” may be media asset reminders, media asset recordings, etc., that are acted upon media assets.

As defined herein the term “artist” refers to any one or combination of: actor, actress, band, singer, celebrity, entertainer, director, producer, magazine editor, politician, reality TV show celebrity, news anchors, TV personality, cartoon character, comic book character, opera singer, consumer product, company, corporate employee, or any similar entities, or specific celebrities or persons. Also, as defined herein the term “perform” or “performance” refers to at least one of acting, speaking, discussing, featuring, dancing, playing music, and appearing in a video.

To obtain a list of artists that are favored by a user, the system receives user input specifying the artists that he/she favors. User input may be textual input and/or user selection. For instance, a user may specify a list of celebrities that he/she is interested in by selecting favored celebrities from a list of celebrities. The list of celebrities may be stored in a database.

Many websites contain information about artists, and specifically, some websites contain information about performances of the artist, for example, an appearance on a segment of a television program. The information about performances describes schedule and non-schedule information about the performance. To extract the information from a website, the textual data on a webpage of the website may be parsed for a key pattern. The information may include schedule or non-schedule information about the performance. For instance, the parsing may be performed by searching for key phrases that indicate schedule information about a performance (e.g., channel and broadcast time information). Regular expressions may be used to assist in parsing for certain keywords that contextually suggest part of the textual data is or is not describing a performance.

To obtain information about the performance from a website, information about the performance may be extracted from the website. In some embodiments, to obtain information from the website, a system may search for a website associated with one of the artists in the list of favored artists. Once a website associated with one of the artists is found from the search, the system extracts information from the associated website. The extracted information indicates that the one of the artists in the list is scheduled to perform during a particular time. Data sources in which information is obtained may not be limited to websites only, and may include syndication feeds such as RSS feeds, or email newsletters.

In some embodiments, the information about the performance is received directly from the web server hosting the website (or any other suitable third party web server). Via an application programming interface, the artist may communicate with the processing server by pushing schedule and/or non-schedule information to the processing server. In some embodiments, the processing server receives a notification from the web server hosting the website that new information about a performance is available. The processing server may pull the information about the performance from the website as instructed by the notification.

Schedule information may describe channel information and the start time of the performance. In one embodiment, schedule information further describes the duration of the performance. Non-schedule information may describe at least one of: name of the media asset associated with the performance and identity of the artist performing during the particular time. In one embodiment, the particular time may be the start time of the performance. In another embodiment, the particular time corresponds to a time interval within the media asset during which the artist starts performing. In some embodiments, the start time is accompanied with the duration of the performance.

To schedule for recording the identified media asset, the system may search in a schedule database of media assets for the media asset that corresponds to the obtained information. An appropriate command for a user equipment corresponding to the user to perform the recording of the media asset may be downloaded. The command is then sent to the user equipment to record the media asset. Other media asset actions such as setting a reminder may also be performed in a similar fashion.

In some embodiments, scheduling for recording may include causing a user equipment corresponding to the user to record the identified media asset. In certain embodiments, causing a user equipment corresponding to the user to record the identified media asset may include adding the recording on a stored list of scheduled recordings on the user equipment. In some embodiments, scheduling for recording the identified media asset may include sending a message to a user equipment corresponding to the user.

If the information obtained about the media asset has changed since the time when an existing recording was scheduled, the system may schedule for recording the identified media asset by updating an existing scheduled recording.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 is a diagram of another illustrative cross-platform interactive media system in accordance with another embodiment of the invention;

FIG. 6 is a detailed diagram of the illustrative cross-platform interactive media system in accordance with an embodiment of the invention;

FIG. 7 is an illustrative display of a screen for providing a list of favored artists in accordance with one embodiment of the invention;

FIGS. 8 and 9 are two illustrative displays of a website at two different times where information is obtained in accordance with one embodiment of the invention;

FIG. 10 is an exemplary data structure for data extracted from a website in accordance with one embodiment of the invention;

FIG. 11 is an exemplary data structure for a media asset corresponding to the data extracted from the website in accordance with one embodiment of the invention;

FIG. 12 is an exemplary data structure for a message sent to user equipment in accordance with one embodiment of the invention;

FIGS. 13-16 are four illustrative displays of a scheduled recordings screen in accordance with various embodiments of the invention;

FIG. 17 is an illustrative display of a scheduled upcoming shows screen in accordance with one embodiment of the invention;

FIG. 18 is an illustrative display of a program reminder in accordance with one embodiment of the invention; and

FIGS. 19-28 are illustrative flow diagrams for scheduling for recording a media asset in accordance with embodiments of the invention.

### DETAILED DESCRIPTION OF EMBODIMENTS

The amount of media available to users in any given media delivery system may be substantial. Consequently, many users desire a form of media guidance through an interface that allows users to efficiently navigate through media selections and easily identify media content that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), recorded programs, and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but may also be part of a live performance. It should be understood that the invention embodiments that are described in relation to media or media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, smart phones, netbooks, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

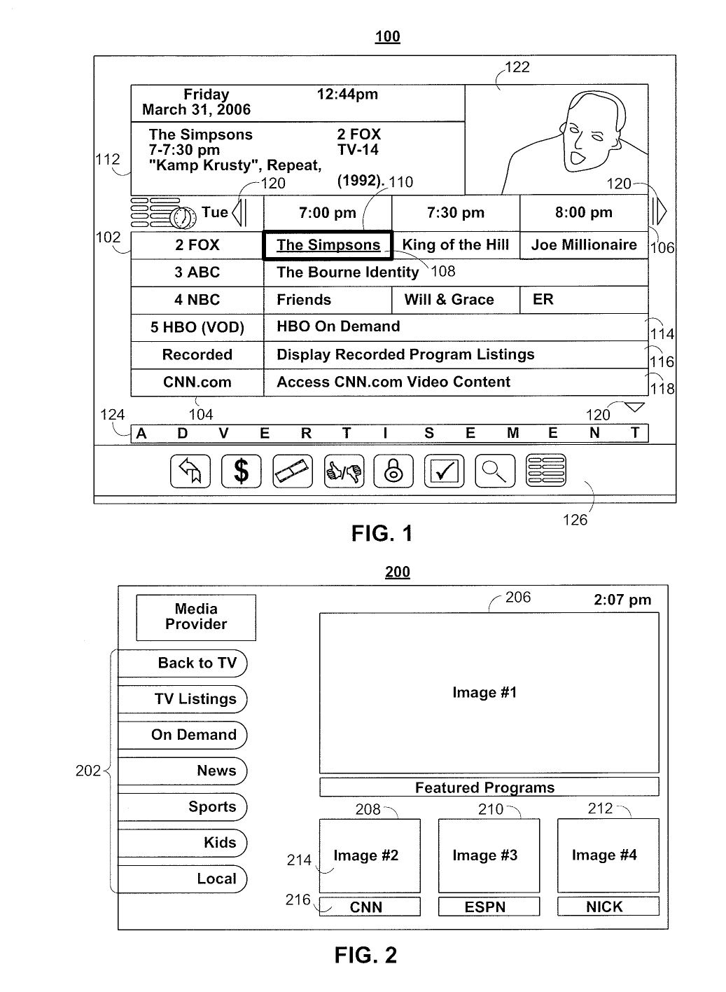

One of the functions of the media guidance application is to provide media listings and media information to users. FIGS. 1 and 2 show illustrative display screens that may be used to provide media guidance, and in particular media listings. The display screens shown in FIGS. 1-2, 7-9 and 13-18 may be implemented on any suitable device or platform. As defined herein, platform refers to any system that may support the operation of an interactive media guidance application. While the displays of FIGS. 1-2, 7-9 and 13-18 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user may select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), media content stored on a networked/remote storage digital video recorder (network DVR or RSDVR), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102. Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display screen or embedded within a display screen. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

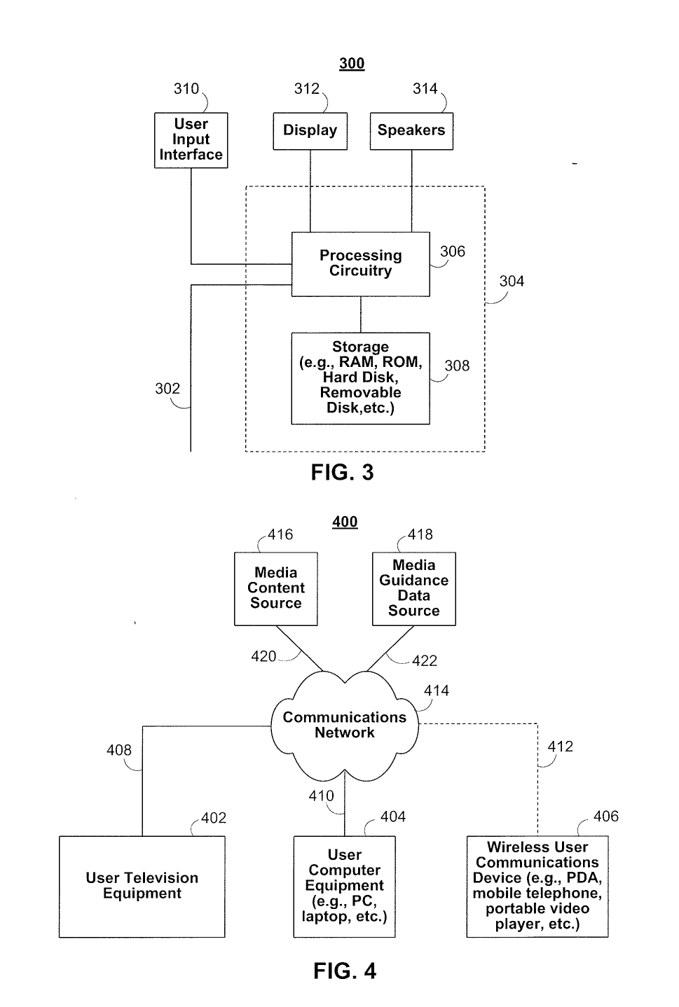

Media guidance application features that may be available through options region 126, or any other suitable selectable options in any other suitable display (e.g., display 200 of FIG. 2), may include, for example, music and interactive game applications. Music applications may be located remotely as on-line music applications or may be stored locally on the user's media guidance equipment (e.g., storage 308 of FIG. 3). Music applications may allow a user to, for example, download music, listen to and/or preview music, organize music libraries, and search for music related to other media guidance information (e.g., music related to program listings in grid 102 of FIG. 1). Interactive game applications may allow a user to, for example, download and play interactive games within the media guidance application. The interactive games may be related to or independent from other media located within the media guidance application. There may be any number of other interactive applications that are accessible via an interactive media guidance application, and these applications may contain content that is complimentary to, or distinct from content provided by the interactive media guidance application.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile, which may be customized for each user who interacts with the media guidance application. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the media guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user may be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. patent application Ser. No. 09/437,304, filed Nov. 9, 1999, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, listings 206, 208, 210, and 212 may be provided, for example, as broadcast program listings. Unlike the listings from FIG. 1, the listings in display 200 are not limited to simple text (e.g., the program title) and icons to describe media. Rather, in display 200 the listings may provide graphical images including cover art, still images from the media content, video clip previews, live video from the media content, advertisements, or other types of media that indicate to a user the media content being described by the listing. Each of the graphical listings may also be accompanied by text to provide further information about the media content associated with the listing. For example, listing 208 may include more than one region, including media region 214 and text region 216. Media region 214 and/or text region 216 may be selectable to view video in full-screen or to view program listings related to the video displayed in media region 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content. For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content. Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

While traditional systems may obtain updates or information about media asset and/or performances from media guidance source 610, it may be advantageous to obtain updates or information about media asset and/or performances from other sources, such as websites, RSS feeds, twitter, blogs, web servers, or any suitable source of information about media assets and/or performances. For instance, the information obtained from these sources may provide the latest update on performances, thereby providing a richer feature to help users access media assets and/or performances in a cross-platform environment.

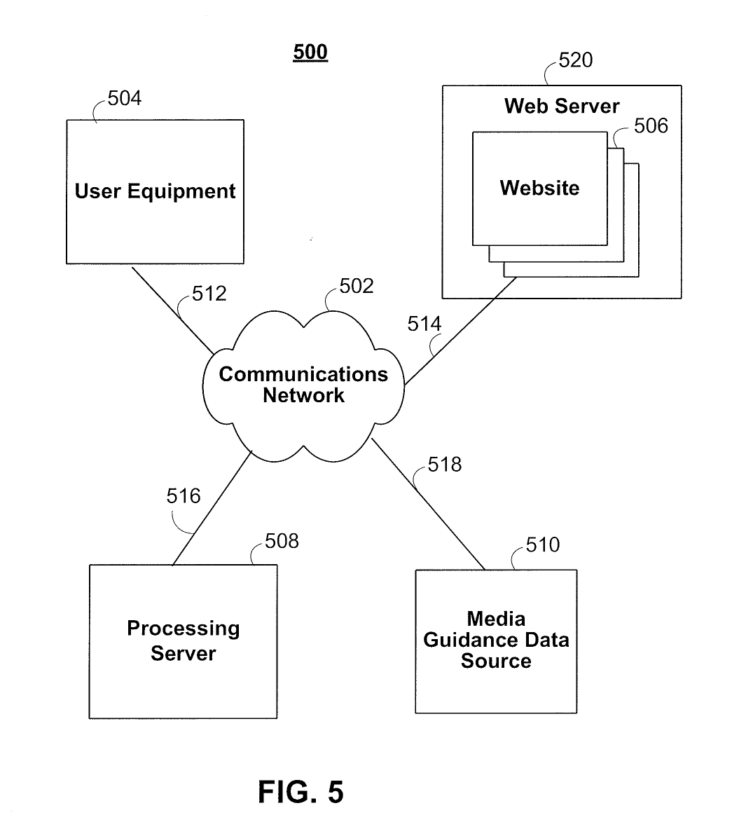

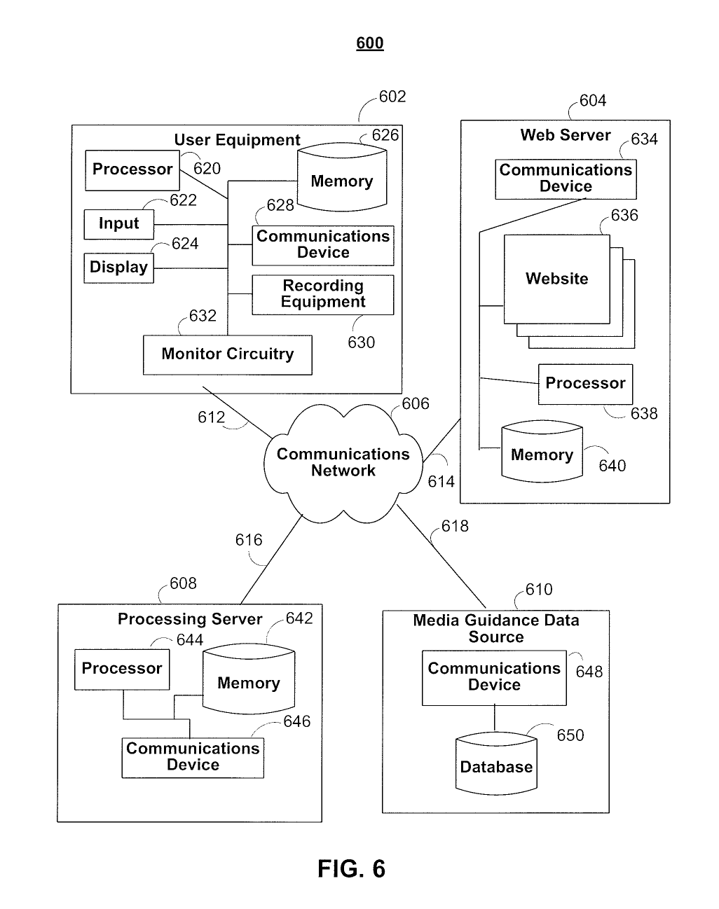

FIG. 5 is a diagram of another illustrative cross-platform interactive media system in accordance with another embodiment of the invention. Details regarding the system is discussed at length in relation to FIG. 6. A modification or variation of system 400 may be implemented as system 500 as shown in FIG. 5. In this embodiment, user equipment 504 associated with a particular user, web server 520, website 506, processing server 508, and media guidance data source 510 are communicably connected via paths 512, 514, 516 and 518 over communications network 502. Details regarding communications network 502 is discussed in relation to communications network 414.

Details regarding user equipment 504 is discussed in relation to user television equipment 402 and FIG. 6. In some embodiments, user equipment 504 may include recording equipment for recording media assets and user interface/input equipment for obtaining a list of favored artists from a user. For instance, user equipment 504 may be a set top box, a mobile device, or a personal computer. In some other embodiments, media assets are recorded in a remote server (not shown) accessible by user equipment 504. For instance, a television program may be recorded and stored remotely from user equipment 504. The user equipment may download and access the television program remotely to consume the media asset.

Web server 520 or a plurality of distributed web servers provides website 506 and is configured to provide at least one website over communications network 502 via path 514. For example, website 506 may be http://www.metallica.com. Each website, such as website 506 has at least one webpage. For instance, website 506 may have a “home” page, a “contact us” page, and a “news” page. Processing server 508 may access website 506 and web server 520 via path 516 and 514 over communications network 502. For example, processing server 508 may access website 506 and web server 620 via a TCP/IP connection over the Internet.

Details regarding media guidance data source 510 is discussed in relation to media guidance data source 418 and FIG. 6. In some embodiments, media guidance data source 418 that includes schedule data is searchable based on information extracted from website 506. For example, media guidance data source 418 may be a database that includes a collection of data about television programs broadcasted to households in Upstate New York that uses Comcast. The data may include schedule and/or non-schedule information about media assets (e.g., television programs, movies, on demand programs, radio programs, music, etc.)

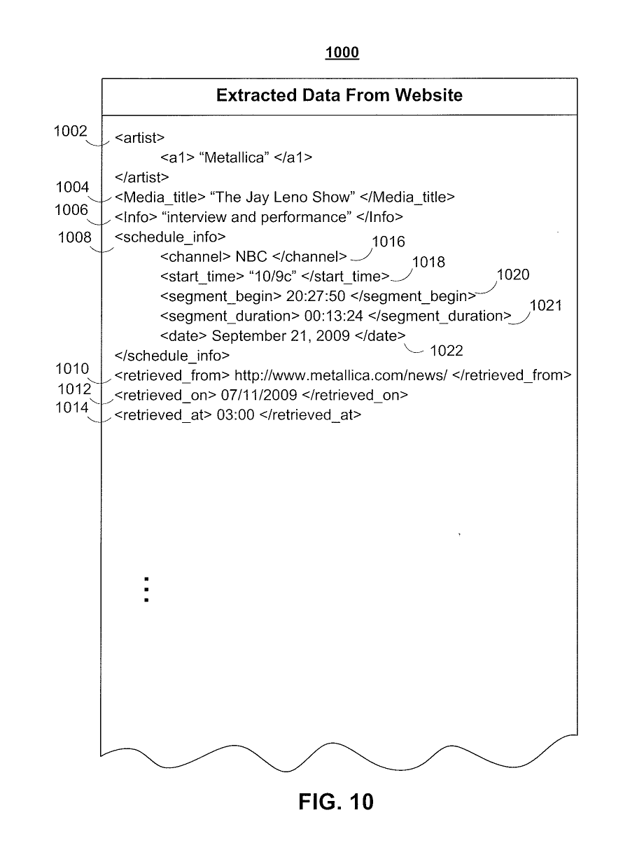

Processing server 508 includes at least one server for downloading webpages and/or other data from web server 520, and extracting information about performances (e.g., using a parser to extract information from an HTML file). In one embodiment, processing server 508 identifies an artist in the list of favored artists, and then retrieves particular webpage(s) in website 506 to extract relevant information about performances of the artist (e.g., using regular expressions to look for keywords on a webpage). In one embodiment, processing server 508 periodically accesses website 506 for new information about performances (e.g., every day, every hour, or twice a day). In another embodiment, processing server 508 receives information from website 506 about new information regarding performances (e.g., when the content of a website has been updated, or when a new blog post has been published on an Real Simple Syndication (RSS) feed). For instance, website 506 may communicate information about performances by sending a communication to processing server 508. Website 506 may provide the information to processing server 508 via a defined application programming interface. For instance, the application programming interface may accept a document/file that uses a defined XML template (an example of a suitable application programming interface), requiring website 506 to provide certain attributes of schedule and/or non-schedule information. An example of an XML file is described at length in relation to FIG. 10. After receiving the communication from website 506, processing server 508 may parse the XML document/file for schedule and/or non-schedule information about the performance, such that a media asset may be identified. Any suitable mechanism or application programming interface may be used to allow communication between website 506 and processing server 508. In some embodiments, website 506 may send a notification to processing server 508 to inform processing server 508 that new information about a performance is available. In some embodiment, website 506 may include the location of the new information in the notification. The location may be a particular webpage of a website (e.g., website 506), a web server, a database, or any suitable data source.

Processing server 508 may process the new information by extracting information about performances. In certain embodiments, processing server 508 actively searches and/or retrieves information from website 506 based on a known list of favored artists, and/or also passively receives information from website 506 about performances (such as updates sent from web server 520. Processing server 508 may matching the information against the known list(s) of favored artists).

Once new information about a performance of an artist in the list of favored artists has been identified from website 506, processing server 508 may communicate with media guidance data source 510 via path 516 over communications network 502 and path 518 to search for and identify the corresponding media asset. For example, processing server 508 may send a message to media guidance data source 510 to query its database (not shown). Media guidance data source 510 may include a set of standardized media asset data that can be understood by user equipment 504 and/or processing server 508 to perform a media asset action, such as scheduling a recording. Media guidance data source 510, or another data source may further include commands and/or messages suitable for causing a media asset action to occur.

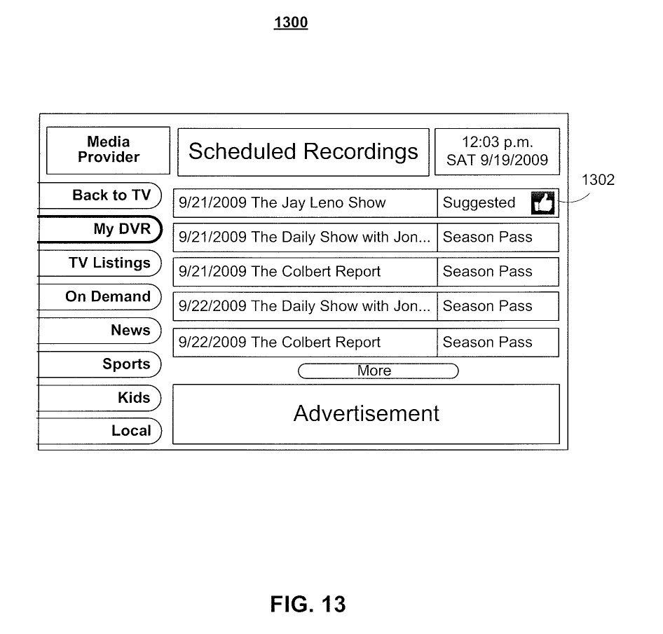

An media asset action may then invoked on the identified media asset by activating the media asset action on user equipment 504. For example, a recording (i.e., media asset action) of “Seinfeld airing on TBS at 4:05 p.m. on Aug. 25, 2009” (i.e., identified media asset) is invoked. Examples of media asset actions are discussed in relation to and shown in FIGS. 13-18. The activation of the media asset action may be performed by processing server 508 by communicating with user equipment 504 over path 516 and 512 through communications network 502. For example, processing server 508 may send a command to user equipment 504 over the Internet.

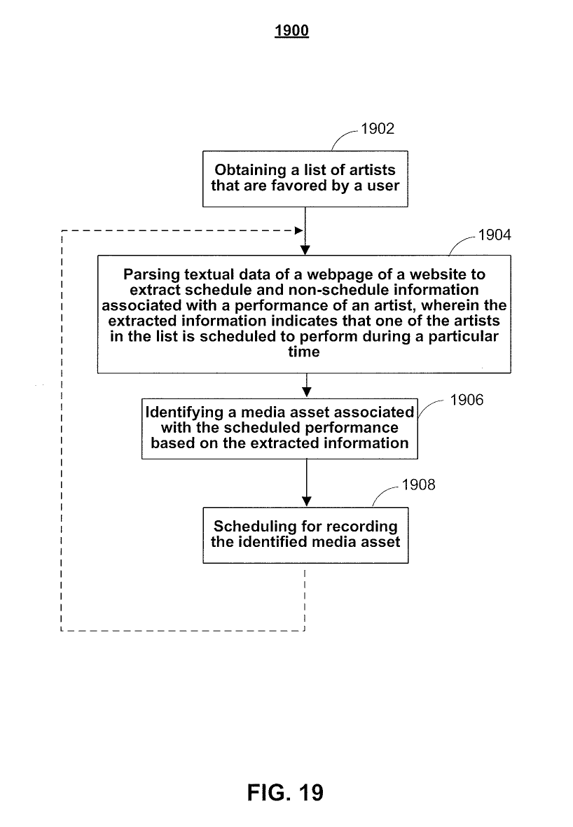

The media asset action may include any combination of: setting up a reminder for the media asset, downloading the media asset, scheduling a recording of the media asset to record the media asset on user equipment, displaying the media asset as an available media asset on an interactive media guidance application, sending an message regarding the media asset to user equipment 504, or any suitable media asset action. Various methods used for scheduling an media asset action are discussed in relation FIGS. 19-27.

While FIG. 5 is described in relation to a single user, system 500 may be configured as a multi-user system. User interests from a plurality of users may be aggregated to create a master list(s) of favored artists. System 500 may utilize a centralized processing server, such as processing server 508, to process information about performance(s) of an artist for a plurality of devices. Alternatively, each user equipment may process information about performance(s) in a distributed fashion (without using a centralized processing method and/or system). System 500 may be configured to receive a list of favored artists from multiple users originating from a plurality of devices. System 500 may also receive information from a plurality of websites in parallel. System 500 may be configured process the information received in parallel. System 500 may be implemented in a distributed fashion such as various methods and processes may be executed in parallel for efficiency.

FIG. 6 is a detailed diagram of the illustrative cross-platform interactive media system in accordance with an embodiment of the invention. User equipment 602, web server 604, website 636, processing server 608, media guidance data source 610, communications network 606, paths 612, 614, 616, 618 have been briefly described in relation to FIG. 5.

User equipment 602 to which the media asset action may be targeted may include processor 620, input 622, display 624, memory 626, communications device 628, recording equipment 630, monitor circuitry 632. User equipment 602 may be a personal computer, a set top box, a laptop, a cell phone, or any suitable user equipment device and/or system the same or similar to media equipment device 300 (FIG. 3). Processor 620 may be any general processor or application-specific processor suitable for performing computations necessary to carry out functions of user equipment 602. Memory 626 may work in conjunction processor 620 to perform the functions of user equipment 602. Memory and processor may include cache storage.

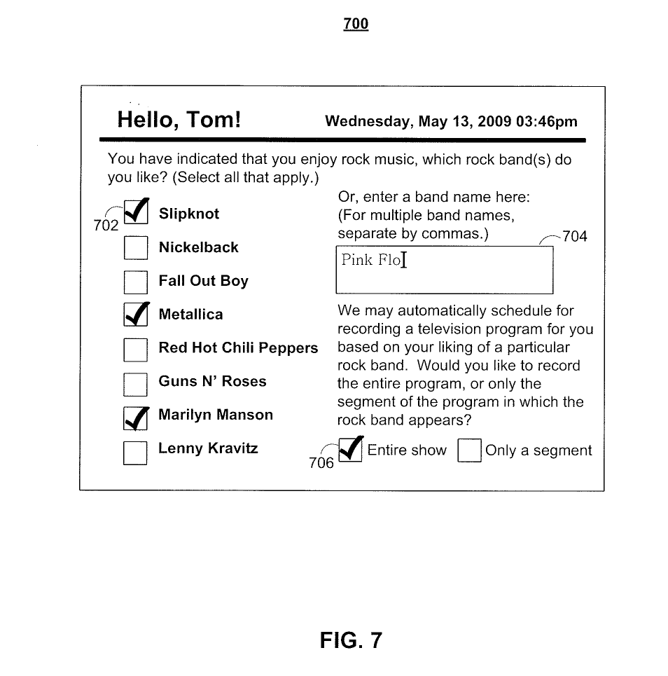

User equipment 602 may obtain a list of artists that are favored by a user via input 622 and display 624. An example user interface is described in relation to and shown in FIG. 7. It is noted that, user equipment 602 may or may not include equipment to which the media asset action is targeted. In one embodiment, user equipment for obtaining a list of artists favored by a user may be a set top box, and the user equipment for performing scheduled recordings may be a personal computer. In yet another embodiment, the scheduled recordings may be performed on the same set top box on which the list of favored artists was obtained.

Input 622 may be any suitable user input device for receiving user input, such a mouse, keyboard, haptic input, touch screen, vocal input, remote control, game controller, etc. A user interface may be generated by monitor circuitry 632 and may be displayed on display 624. Interface 700 may be generated by an interactive media guidance application or any application running on user equipment 602. Interface 700 may also be a webpage generated by a web server configured to collect user input from a user.

Display 624 may be a projection-type TV, an LCD TV, or an LED TV, or any suitable display equipment for displaying screens to a user. Communications device 628 may be configured to allow user equipment 602 to communicate with other devices on communications network 606, such as via the Internet. Communications device 628 may be an Ethernet card, a modem, or any suitable communications device.

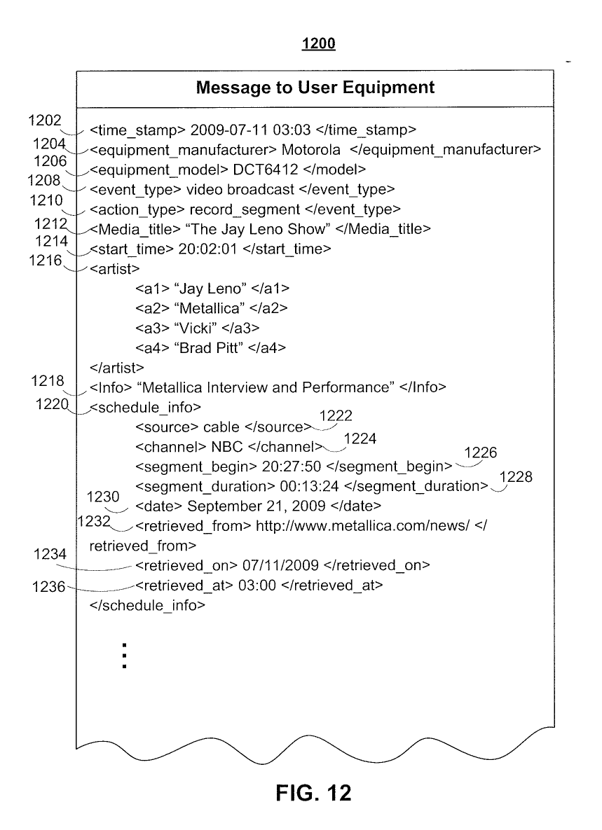

Recording equipment 630 may be a video cassette recorder, volatile memory storage, a hard disk, a solid state drive, a dvd writer, a cd writer, a blu-ray disk writer, or any suitable device for recording media assets. Recording equipment 630 may be configured to receive commands via communications device 628 from other devices on the network. An example of a command is discussed in relation to and shown in FIG. 12. Alternatively, recording equipment 630 may be controlled and commanded processor 620 of user equipment 602.

Web server 604 includes communications device 634, processor 638 and memory 640, which are described in relation to communications device 628 processor 620 and memory 626. Web server 604 further includes website 636, as discussed in relation to website 506. Website 636 includes an application, such as .NET or Apache, running on processor 630 configured to receive, process, and respond to requests from users for webpages. Website 636 includes at least one webpage accessible to devices connected to communications network 502 via path 514. Activity such as access and requests to webpages may be logged and such a log may be stored in memory 640.

Webpages may be implemented in HTML, Perl, php, SQL, ASP.NET, ajax, or any programming and/or markup language in any suitable framework for delivering web content. Web server 520 may be configured to process web requests to provide web pages to other devices connected on communications network 502. In some embodiments, web server 520 broadcasts and/or distributes data (e.g., RSS feeds) to other devices connected on communications network 502. Memory 640 may store databases that provide data for website 636. Memory 640 may also provide a storage medium for storing webpages.

Website 636 may contain information regarding performances of artists. Website 636 may be an official website of an artist, a news website, a gossip website, a twitter page, or any website that may contain information about artists and/or performances. In some embodiments, website 636 may be a website about a plurality of artists, such as a website about movie stars. In one embodiment, website 636 may be a blog. In another embodiment, website 636 may be a content aggregator that collects and presents data from a plurality of sources. In yet another embodiment, website 636 may be a website for a television program. In another embodiment, website 636 may be a website of a local television programming provider.

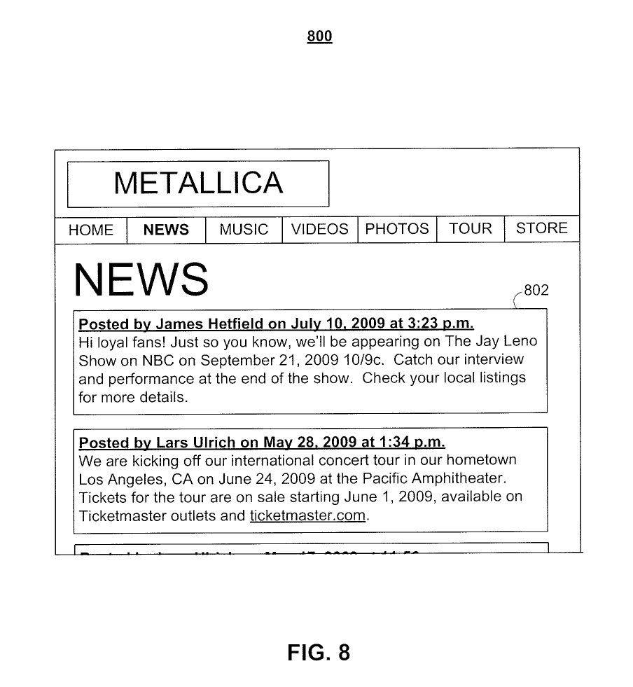

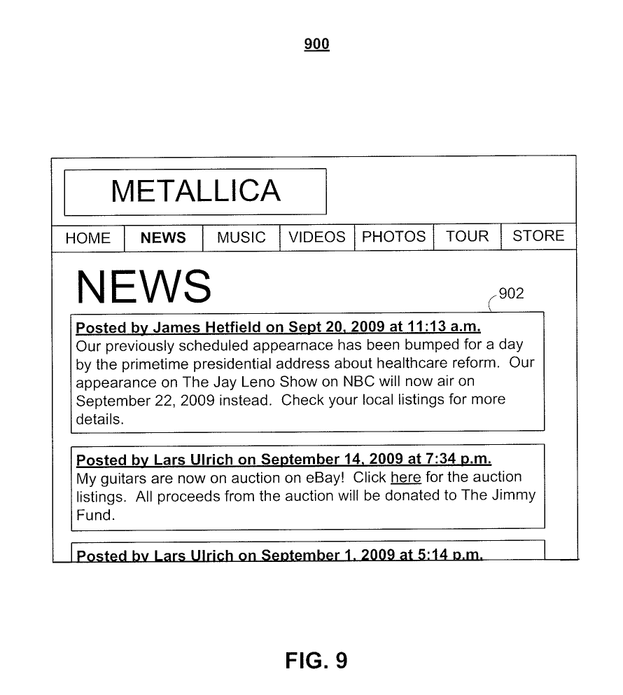

Information indicating that one of the artists in the list of favored artists may be obtained from website 636 and its webpages. For example, a twitter web page may announce that an artist is schedule to appear on ABC on Sep. 3, 2009. The information may be extracted from the twitter web page. Example screens of a website is shown in and discussed in relation to FIGS. 8 and 9. Example data extracted from website 636 is shown in and discussed in relation to FIG. 10.

Web server 604 may also be configured to implement communication services such as email, text messaging, instant messaging, video conferencing, voice over IP (VOIP), or voice mail. Web server 604 may also be configured as a file server, such as an FTP or SVN, capable of providing access, management, and storage of data and/or files. Various functionalities of web server 604 may be requested by remote devices on communications network 502.

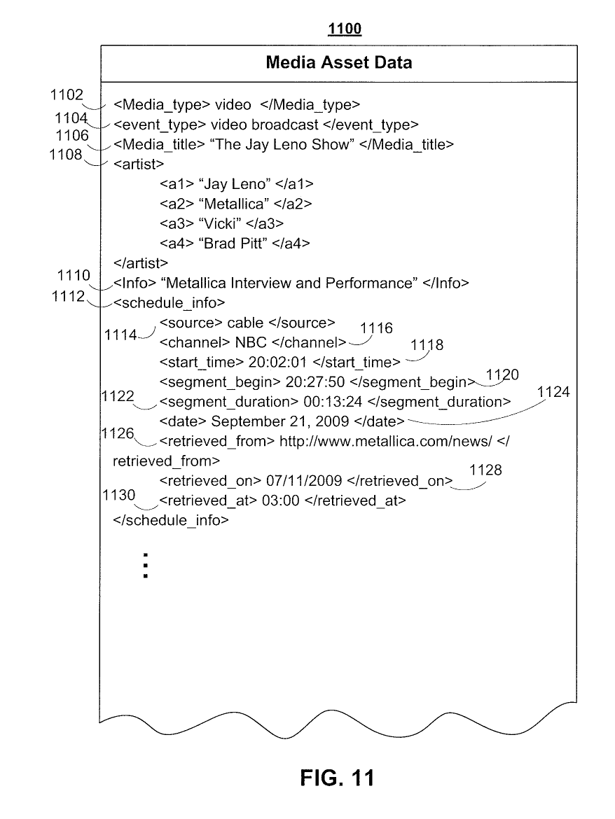

Media guidance data source 610 may be configured to provide access and storage of media guidance data, where the media guidance data may include information and/or metadata about a plurality of media assets. Media guidance data source 610 includes communications device 648 and database 650. Communications device 648 is discussed in relation to communications device 628, and is configured to allow other devices connected to communications network 606 to communicate with media guidance data source via path 618. Implementation details about media guidance data source 610 is discussed at length in relation to FIGS. 4 and 5. An example data structure of media guidance data stored in database 650 is shown in and described in relation to FIG. 11.

Processing server 608 may be configured to maintain a user's list(s) of favored artists and identifying information from a website about a performance by one of the artists in the list. Processing server 608 may identify the corresponding media asset in media guidance data source 610. For example, if plain text “Bill Clinton will appear on Sesame Street this Sunday”, processing server 608 may search/query the media guidance data source 610 for Sesame Street airing on the upcoming Sunday, identifying the channel and time of the show. By identifying the media asset in media guidance data source 610, processing server 608 has sufficient and adequate information to schedule an action associated with the media asset (e.g., identified media asset provides schedule information for processing server 608 to schedule a recording). Processing server 608 may schedule a media asset action on user equipment 602 (e.g., a program reminder is scheduled for “The Colbert Report” series). Functionalities of processing server 608 may be separately implemented on multiple devices or processing servers. In some embodiments, some or all functionalities may be implemented on devices such as user equipment 602 or web server 604.

FIG. 7 is an illustrative display of a screen for providing a list of favored artists in accordance with one embodiment of the invention. Interface 700 may be shown on display 624 via monitor circuitry 632, and may be generated by processor 620. Interface 700 may be generated by an interactive media guidance application or an application running on user equipment 608. Interface 700 may also depict a screen shot of a web page viewable on user equipment 602, and configured to receive user input. Using input 622, a user may provide input to user equipment 602 about his/her preferences. In one embodiment, a user provides a list of artists that are favored by a user via interface 700. For instance, a user, Tom, may click on checkbox 702 to indicate that Tom likes Slipknot. Alternatively, Tom may type in “Pink Floyd” into textbox to indicate that Tom enjoys Pink Floyd.

Interface 700 may be implemented on a standalone application running on user equipment 602, such as an interactive media guidance application. Interface 700 may also be a web-based application. Information collected from interface 700 may be stored in memory 626 or sent to processing server 608 for storage in memory 624. Alternatively, information collected may be stored and maintained in another device not shown in FIG. 6. Screen 700 is illustrative, other questions or design of interfaces may be used to achieve the same purpose of collecting user interests in various artists.

A user may be asked once about his/her interests in artists, or may be asked to provide information at different times. For example, the user may be asked about his or her interests when he or she is using user equipment 602 for the first time. The user may also be asked to confirm his or her interest during the course of using user equipment 602. If the system infers that the user may like the band “Red Hot Chili Peppers”, the user may be prompted to confirm whether he/she likes “Red Hot Chili Peppers”. In some embodiments, a user's preferences may be learned and/or inferred over time based on a user's interactions and habits with user equipment 602. In some embodiments, a user is prompted to confirm his/her inferred preferences via an interface similar to interface 700.

A user may be prompted by a plurality of screens to provide interest in different kinds of artists, such as performers, actors, actresses, bands, celebrities, dancers, singers, etc.

A user's interests and/or preferences may be stored in a user profile associated with the user. The user profile may be stored locally on user equipment 602, or it may be stored remotely from user equipment 602 on a different server, such as processing server 608, or any suitable remote server accessible to user equipment 602.

Interface 700 may include any of and/or any combination of checkboxes such as checkbox 702, text boxes such as text box 704, drop down lists, radio buttons, or any suitable interface elements.

In some embodiments, the user may be provided with the option to choose whether to record a segment of the media asset in which the artist is performing in, or the entire media asset in which the artist is performing. For instance, as shown on interface 700, a user has opted to record the entire show, in response to the question, “We may automatically schedule for recording a television program for you based on your liking of a particular rock band. Would you like to record the entire program, or only the segment of the program in which the rock band appears?” by selecting “entire show” in checkbox 706.

If a user has indicated that he/she would like to record the entire show, identified media asset based on the list of favored artists would be recorded in its entirety. If a user has indicated that he/she would like to record a segment of the show only, then only a segment of the identified media asset would be recorded. If a user has not indicated whether he/she would like to record an entire or a segment of the identified media asset, then a default action (e.g., system may default to record the entire media asset) would be taken.

FIGS. 8 and 9 are two illustrative displays of a website at two different times where information may be obtained in accordance with one embodiment of the invention. Screen 800 is a screenshot of an exemplary website of a band called “Metallica”. It should be noted that Tom has indicated a particular interest in Metallica in interface 700. Details of a website implemented on a web server is discussed at length in relation to FIG. 6.

On the news section of the website, posts about recent happenings are displayed. Post 802 indicates that the band will be appearing on The Jay Leno Show on MBC on Sep. 21, 2009 at 10/9 central. Post 802 further indicates that Metallica will be interviewed and will also perform at the end of the show.

In one embodiment, a user has expressly indicated his/her interest in Metallica. Knowing the user's interest in Metallica, processing server 608 or any suitable server may access Metallica's website to obtain information about the band from Metallica's official website. For example, processing server 608 may have an application that is configured to send an HTTP request to the server hosting the website with the URL http://www.metallica.com to access the website (e.g., request to download an html page). In certain embodiments, the HTML page may be downloaded and prepared for further processing. For instance, the HTML file may be parsed for salient keywords, such as “appear”, “featuring”, etc., that indicates information about a media event. In some embodiments, the HTML file, or the downloaded webpage file, embeds metadata, and processing server 608 scans for relevant metadata. Alternatively, processing server 608 may visit a website about a plurality of rock bands, or rock music culture in general, to obtain information about performances.

In another embodiment, processing server 608 may regularly check Metallica's website (and any other websites where information about performance is believed or known to be shared) with or without the knowledge of a user's preferences. Processing server 608 may visit a plurality of these websites at periodic intervals such as every hour, or once a day. Processing server 608 may employ a web crawler to gather updates from websites.

In yet another embodiment, processing server 608 may be prompted by web servers such as web server 604 to download and/or receive information about upcoming performances, where web server 604 may send a message to processing server 608 containing a request to visit the website and/or information about an upcoming performance.

Websites such as one shown in FIGS. 8 and 9 may include at least one of: plain text, images, scripts, flash objects, videos, audio, or any suitable web content. Accordingly, processing server 608 may be configured to parse data files of webpages in websites to find keywords that indicate information about performances. Other suitable methods to detect information about performances in data files may be used. An example method is to use a set of regular expressions to detect certain keywords such as “interview”, “appearing”, or channel names such as “NBC” or “MTV”. One of ordinary skill in the art may employ other suitable methods to extract and obtain information about upcoming performance events from websites. In some embodiments, webpages in websites may embed structured data to inform processing server 608 of the information about an upcoming performance, and provide the information in a structured data format. An illustrative example of data extracted from a website is discussed at length in relation to FIG. 10. FIG. 10 may also be an example of structured data, or at least in part, directly embedded in a webpage such as one shown in FIGS. 8 and 9.

Scheduled performances may change. Screen 900 is a screenshot of the Metallica website taken at a later time. Newer posts in the news section are shown, including post 902. Post 902 indicates that the previously schedule appearance has been moved for a day, due to a scheduling conflict with a presidential address about healthcare reform. Post 902 also indicates that the appearance on The Jay Leno Show is now airing on Sep. 22, 2009. Furthermore, post 902 indicates that a presidential address about healthcare reform is scheduled to be broadcasted.

In a similar fashion as the methods described in relation to FIG. 8, processing server 608 may detect, extract, and store information about the upcoming performance from webpage shown in screen 900. An example of extracted data is shown in FIG. 10. In some embodiments, the extracted data may be at least in part directly embedded in webpage shown in FIG. 9. Screen 900 illustrates that extracted data may become outdated, and that the information about the scheduled performance may need to be updated. Processing server 608 may periodically check for updates from webpages such as one shown in FIGS. 8 and 9. Some websites may notify processing server 608 of scheduling changes.

In some embodiments, processing server 608 tracks and records previously extracted data and compare it with newly extracted data to determine if new information extracted from websites conflicts with past extracted data. If a conflict exists, new information about the performance may be used to update the records, and the corresponding media asset is identified, and the appropriate media asset action is then executed. For example, processing server 608 may receive a new post from an RSS feed that indicates that Bill Clinton's appearance on 60 minutes has been cancelled until further notice due to a football game running over time. In response to receiving the updated information about the show, if there was a previously scheduled recording for that segment of 60 minutes, processing server 608 may send a message to user equipment 602 to cancel the scheduled recording.

In one embodiment, a list of companies may be received from the user indicating that he/she is interested in those companies. A user interface similar to interface 700 may be used. For example, a user may input a list of stock symbols for a user profile (e.g., NYSE:GSK, NYSE:MRK, and NYSE:MTU, etc.) for which the user would like to view in his/her stock ticker bar on screen. GlaxoSmithKlein's (NYSE:GSK) CEO, Andrew Witty, has announced on his company blog that he will appear on CNBC to discuss his mission to create a successful low cost H1N1 vaccine at 10 am on Sep. 4, 2009. Knowing the user's interest in GlaxoSmithKlein, the appearance of the CEO on CNBC's television program, “Squawk on the Street” is then scheduled to be recorded on the user equipment corresponding to the user and user profile.

In another embodiment, Anderson Cooper blogged about his special investigative report on GlaxoSmithKlein airing at 7:00 p.m. on Sep. 6, 2009. Knowing the user's interest in GlaxoSmithKlein, processing server 608 may identify that the associated media asset is “AC360” on CNN. A recording for “AC360” is then scheduled to be recorded on the user equipment.

In yet another embodiment, a user may provide a list of favored entities such as products, type of products, and/or brand names. For instance, a user may, using an interface similar to interface 700, to input a list of entities. Examples of entities include “Nike”, “Apple”, “Mars Candy”, “Ferrari”, “X-Files” etc. Information may be obtained from websites (e.g., product websites, movie websites, etc.,) that indicates that at least one of the entities are scheduled to perform (e.g., appear) on a scheduled program. For instance, the official movie website of “Valkyrie” announced that an movie critic's review is schedule to air on “Rotten Tomatoes” at 8:15 p.m. on Sep. 1, 2009. Accordingly, media assets are identified based on the information obtained, and are scheduled to be recorded. For instance, the media asset “Rotten Tomatoes” is identified, and subsequently scheduled to be recorded.

FIG. 10 is an exemplary data structure for data extracted from a website in accordance with one embodiment of the invention. As discussed in relation to FIGS. 8 and 9, the data extracted may be constructed and populated by using processing server 608 to parse the webpage or by any other suitable method. In some embodiments, the data extracted may be at least in part directly embedded in the webpage. Data structure 1000 shows a set of metadata about the performance as extracted from a webpage. Note that the data structure is only exemplary, other suitable data structures may be used. Data structure 1000 may store data (such as strings extracted from an HTML page) exactly as it is extracted from the webpage. In some embodiments, data structure 1000 stores data that may have been processed by processing server 608 (e.g., “metallica” may be processed and converted to “BAND: Metallica”). Processing may include correcting typos and/or striping special characters, or any suitable processing that allow the data to be stored property, or any suitable processing that helps processing server 608 to identify the corresponding media asset later on. For instance, processing server 608 replaces “10 pm” with a standardized time stamp, or replaces “Sep. 4, 2009” with “2009-09-04”.

It is noted that not all websites provide information for all the fields as listed in data structure 1000. If no data was provided, or if processing server 608 was not able to extract data for a certain field, the field may be left blank. Alternatively processing server 608 may be configured to infer the data and fill in the information in the missing field. For instance, if time and channel information was extracted, processing server 608 may search for the media title using database 650 in media guidance data source 610. In certain embodiments, processing server 608 may be configured to infer full names from acronyms or nicknames, such as translating “Bradgelina” to “Brad Pitt” and “Angelina Jolie” by using a look up table). In some embodiments, data records of information extracted from websites may be flagged for manual editing by a human operator. Or if similar data is retrieved from multiple sources, information that is common across the multiple sources (commonality may be measured by the proportion of sources that share the same or substantially similar data) may be used for a particular data record. Or if data retrieved at a later time provides the data that was missing before, the data retrieved at a later time may be used.

Artist field 1002 stores a list of at least one artist appearing for the performance. At least one artist may be stored in the data structure. In some embodiments, the name of the artist in plain text may be stored in artist field 1002. In other embodiments, a unique identification code that represents the artist may be stored. A look up table of known artists, indexed by uniquely identifiable codes, may be used to determine the name of the artist in plain text. In some other embodiments, a pointer to another data structure may be used to identify the artist appearing in the performance.

Media title field 1004 stores the title of the media asset as extracted from the webpage. For instance “The Jay Leno Show” identifies the name of a television program. Similar to artist field 1002, processing server 608 may use a look up table of media titles and unique identification codes, and store a unique identification code of a media title instead of the plain text data of the media title. Media title field 1004 may help processing server 608 determine the corresponding media asset in the media guidance data source 610. Processing server 608 preferably uses media title field to search database 650 in media guidance data source 610 to identify the corresponding media asset.

Info field 1006 stores the miscellaneous non-schedule information that describes the performance. In this embodiment, info field 1006 stored salient keywords “interview and performance” about the particular performance shown in FIGS. 8 and 9. Any sort of non-schedule information may be stored in info field 1006.

Schedule info field 1008 stores schedule information about the performance. Schedule information includes channel field 1016, start time field 1018, segment begin time field 1020, segment duration field 1021, date field 1022.

Channel field 1016 shown in exemplary data structure 1000 stores the name of the broadcaster, which was extracted from the webpage shown in FIGS. 8 and 9. It is noted that broadcasters may be broadcasted on different channels depending on the cable/satellite provider, location, or other factors. In this embodiment, “NBC” is stored in the channel field. In other embodiments, processing server 608 may store local channel information in channel field 1016 such as “WNBZ” or “7” depending on the application.

Start time field 1018 stores the time information as extracted from the webpage. “10:00 p.m.” or “22:00” may also be used. Note that in this exemplary data structure 1000, start time field 1018 is storing the start time of the television program on which Metallica is appearing.

Date field 1022 stores the date as extracted from the webpage. Other formats may be used such as “09-21-2009” or “20090921”.

In some embodiments, the artist is only appearing during a segment of the television program, and an option is provided to perform a media asset action on the particular segment of the media asset. Although screen 800 does not show the duration and time in which the segment begins, the data may be embedded in the webpage, and may be extracted by processing server 608. Alternatively, the schedule information about a particular segment of a media asset may be explicitly stated on the webpage.

Marking the time, date, origin of retrieval of data allows processing server 608 to track the history of when and where information was extracted. The retrieval data may be used to determine whether the data needs to be updated with information extracted at a later time. In one embodiment, the data is by default overwritten when new data for the same media asset is obtained and extracted at a later time.

Retrieved from field 1010 stores the URL of the webpage in which the data was extracted from. In some embodiments, retrieved from field 1010 may store the IP address of a server that provided the information about the performance. In other embodiments, retrieved from field 1010 may store a unique identification code for identifying the source of the information about the performance.

Retrieved on field 1012 and retrieved at field 1014 stores the date and time, respectively, in which the data was retrieved. The date and time in which data was retrieved allow processing server 608 to determine whether the information is outdated or needs to be updated. Date and time may be stored in different formats in fields 1012 and 1014, depending on the application. Fields 1012 and 1014 may be combined into a single field using a timestamp that includes both date and time.

After the information from the website is extracted and stored in data structure such as data structure 1000. At least some part of the data in data structure 1000 may be used to identify the corresponding media asset in media guidance data source 610. By identifying the corresponding media asset in database 650, the system may cause a media asset action to occur on the corresponding media asset. One advantage of identifying the corresponding media asset instead of sending the raw data as it is extracted from the website to user equipment 602 is that system 600 can leverage the processing server 608 to understand the data and translate it into an appropriate data structure and/or message and/or command that user equipment 602 can readily understand. For example “10/9c p.m.” may not be easily understood by user equipment to mean 10:00 p.m. Eastern and 9:00 p.m. Central.

One method of identifying the corresponding media asset in media guidance data source 610 is to find the best match based on fields such as media title field 1004 and 1006, artist field 1108, and schedule info field 1112. Any combination of fields may be used as long as the combination is suitable for the search.

Furthermore, broadcasters may be broadcasting on different channels depending on the location of user equipment 602, and media guidance data source 610 may provide the local channel mapping data such that the media asset action may be properly executed. For instance, if “NBC” was extracted to be the channel information, media guidance data source may translate NBC to channel 23, so that user equipment 602 may be able to record the media asset and tune the TV tuner to the appropriate channel.

FIG. 11 is an exemplary data structure for a media asset corresponding to the data extracted from the website in accordance with one embodiment of the invention. Data structure 1100 is an illustrative example of a media asset data record of a corresponding media asset of the extracted data from website shown in FIG. 10. Data structure 1100 includes sufficient information for a media asset action to occur. The fields in data structure 1100 may be populated by using information extracted from website, such as data shown in data structure 1000, and also using data stored in database 650 in media guidance data source 610. Data structure 1100 includes media type field 1102, event type field 1104, media title field 1104, artist field 1108, info field 1110, schedule info field 1112.

Media type field 1102 stores the type of the media asset, such as “video”, “audio”, or any suitable that identifies the type of the media asset. Event type field 1104 stores the type of the event, such as “video broadcast” or “audio on demand”. Unique identification codes may also be used in fields 1102 and 1104, or any other fields in data structure 1100.

Media title field 1106 is discussed in relation to media title field 1004. Artist field 1108 stores at least one artist appearing on the show. As shown in this illustrative example, the list in artist field 1108 include “Metallica”, matching the artist listed in artist field 1102 of data structure 1000. In some embodiments, the media asset data may not list all the artists that are appearing on the media asset, but the system may match the extracted data from the website (e.g., data structure 1000) with media asset data (e.g., data structure 1100) using other fields such as schedule info field 1008.

In some embodiments, data extracted from website such as information in data structure 1000 may be used to populate fields in media guidance data source 610. In certain embodiments, system 600 may require data from at least a certain number of sources to ensure that the data extracted from websites is reliable.

Info field 1110 is discussed in relation to info field 1106.

Schedule info field 1112 includes source field 1114, channel field 1116, start time field 1118, segment begin time field 1120, segment duration field 1122, date field 1124, retrieved from field 1126, retrieved on field 1128, and retrieved at field 1130. These fields are discussed at length in relation to FIG. 10. Schedule info in media asset data may include more specific information about the media asset such that the media asset action may be properly executed. For instance, source field 1114 provides the appropriate information for user equipment 602 to tune to the correct signal for the media asset. Schedule info field 1112 may be populated using information extracted from website, such as the data in schedule info field 1008.

In certain embodiments, a message and/or a command may be sent to user equipment to execute a media asset action. The message and/or command includes information about the action, and provides information for the equipment to execute the media asset action.

FIG. 12 is an exemplary data structure for a message sent to user equipment in accordance with one embodiment of the invention. Message to user equipment includes time stamp field 1202, equipment manufacturer field 1204, equipment model field 1206, event type field 1208, action type field 1210 and start time field 1214. Event type field 1208, media title field 1212, start time field 1214, artist field 1216, info field 1218, schedule info field 1220, source field 1222, channel field 1224, segment begin time field 1226, segment duration field 1228, date field 1230, retrieved from field 1232, retrieved on field 1234, and retrieved at field 1236 are discussed at length in relation to FIGS. 10 and 11.

Time stamp field 1202 allows system 600 to track when media event actions are scheduled. If there is new information obtained about a particular media event, the media event action previously executed may have to be cancelled, updated and/or modified. Time stamp field 1202 allows processing server 608 to determine when a specific media event action (such as scheduling a recording) had been executed, and whether the media event action has to be executed again in light of the new information (e.g., rescheduling of a performance).

Equipment manufacturer field 1204 and equipment model field 1206 allows system 600 to track that the message is targeted for a particular type of user equipment. For example, equipment manufacturer field 1204 may be populated with “Toshiba”, “Sony”, “Samsung”, “Motorola”, “Cisco”, “Pace” or a unique identification code that identifies a particular equipment manufacturer; equipment model field 1206 may be populated with “100MX-White”, “NMF8009-X3”, or any suitable identifier that uniquely identifies the model name of the user equipment. Additionally, fields 1204 and 1206 allows system 600 to track compatibility by informing system 600 that the message is formatted for a particular type of user equipment. A single field, or more than 2 fields may be used to identify the kind of user equipment or the communication protocol compatible with the user equipment. For example, a field for “communications protocol” may be populated with “rovi XML ver. 4.5” as a label for the protocol used. Any suitable field and data may be used to correctly allow processing server 608 to communicate with user equipment 602.

Event type field 1208 identifies the kind of media asset that the message is intended for. For instance, event type may be a “video broadcast”, or a “podcast”, or a “audio broadcast”, or any suitable event type identifier.

Action type field 1210 allows the message to identify the intended media asset action, such as reminders for media assets, recordings for media assets, etc. In one embodiment, the message sent to user equipment 602 is a command to record a particular segment of a television broadcast program. Accordingly, the event type is a “video broadcast” and the action type is “record segment”. In another embodiment, the message sent to user equipment 602 is to set a program reminder for a radio program. The event type is, accordingly, “radio broadcast” and the action type is “set program reminder”.

FIGS. 13-16 are four illustrative displays of a scheduled recordings screen in accordance with various embodiments of the invention.

FIG. 13 is an illustrative display of a scheduled recordings screen of an interactive media guidance application. In one embodiment, a user has indicated that he/she likes the band “Metallica”. This indication has been received and may be used to obtain information from Metallica's website. On Metallica's website, such as one shown in FIG. 8, a performance an interview is scheduled during a segment of The Jay Leno Show on Sep. 21, 2009. The media asset, namely The Jay Leno Show, is identified, and The Jay Leno Show is scheduled for recording. In some embodiments, only a segment of The Jay Leno Show is scheduled for recording. For example, Metallica may only appear during a segment of the show where Jay Leno interviews Metallica. Accordingly, only that segment of the television show is schedule to be recorded. In some embodiments, it may be desirable to record the commercials that are broadcasted before and/or after the segment. Item 1302 on screen 1300 is part of a list of scheduled recordings on the system, indicating that The Jay Leno Show on Sep. 21, 2009 has been scheduled for recording. Additionally, item 1302 shows an icon and text indicating that the show was suggested by system 600, as opposed to shows that are manually scheduled by the user. In another embodiment, item 1302 may show that only a segment has been scheduled for recording.

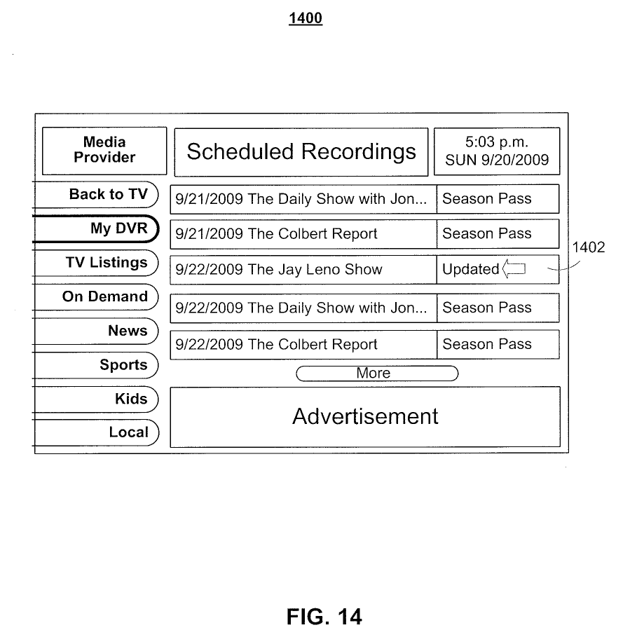

FIG. 14 is an illustrative display of an updated scheduled recording screen of an interactive media guidance application. In certain embodiments, processing server 608 updates an existing scheduled recording, such as item 1302 in FIG. 13, if the information obtained about the media asset (i.e., The Jay Leno Show) has changed since the time when the existing recording was scheduled. An updated recording is then displayed on screen 1400. For instance, processing server 608 may receive new information about a performance. An example of a website providing new information is shown in FIG. 9. Processing server 608 and/or user equipment 602 may determine from time stamp field 1202 or any other data structure whether the scheduled media asset action needs to be updated. Item 1302 in the list of scheduled recordings indicates that an item has been updated. For instance, the Metallica website shown in FIG. 9 shows that the performance and interview was moved to Sep. 22, 2009. Accordingly, the new information about the performance is obtained and is used to update the scheduled recording of The Jay Leno Show. Item 1402 has text and an icon to indicate that item 1402 is an updated recording.

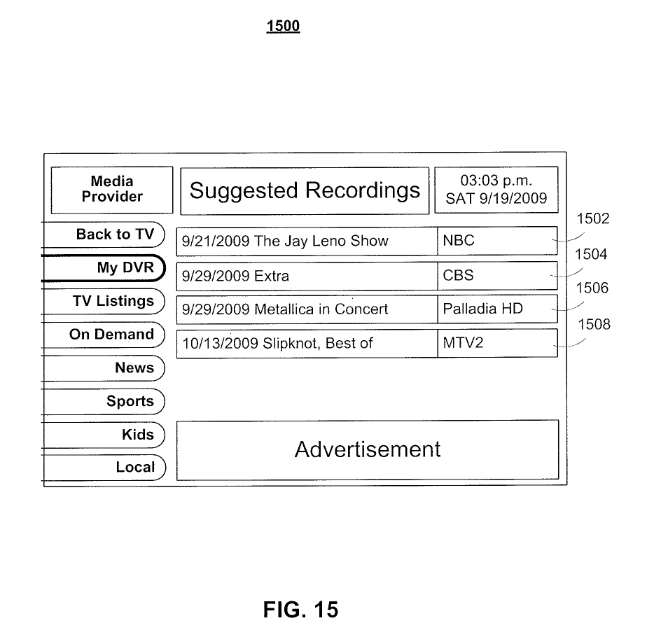

FIG. 15 is an illustrative display of an scheduled recording screen of an interactive media guidance application in an another embodiment. Screen 1500 shows a list of suggested recordings for all scheduled suggested recordings. Item 1502 and item 1506 may have been scheduled because of a user's interest in Metallica, and Metallica is scheduled to perform during The Jay Leno Show on Sep. 21, 2009 and on Metallica in Concert on Sep. 29, 2009. Item 1504 may have been scheduled because a celebrity that a user is interested in (e.g., the celebrity is in the list of artists favored by the user) being featured on Extra. Item 1508 may have been scheduled because of the user's interest in Slipknot, as shown in FIG. 7. Other media assets may also be scheduled depending on the list of artists that are favored by the user. For instance, if a user has indicated that he/she favors Britney Spears, processing server 608 may schedule for recording her appearance on “MTV Movie Awards 2009” (i.e., identified media asset). “MTV Movie Awards 2009” may appear on the list of suggested recordings, or scheduled recordings.

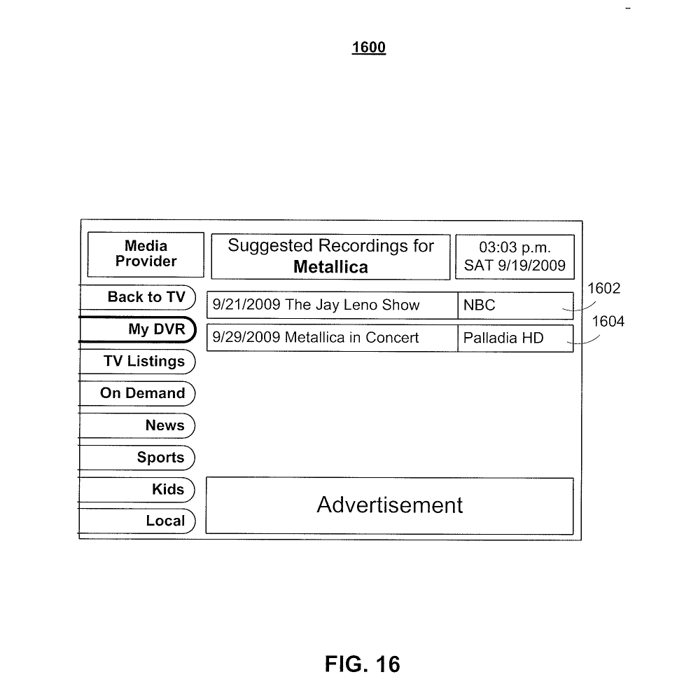

FIG. 16 is an illustrative display of an updated scheduled recording screen of an interactive media guidance application in yet another embodiment. Rather than showing a list of suggested recordings for all the artists on the list of favored artists, screen 1600 shows only suggested recordings for a particular artist. For example, a list of recordings in which Metallica is performing, the list including items 1602 and 1604, is listed.

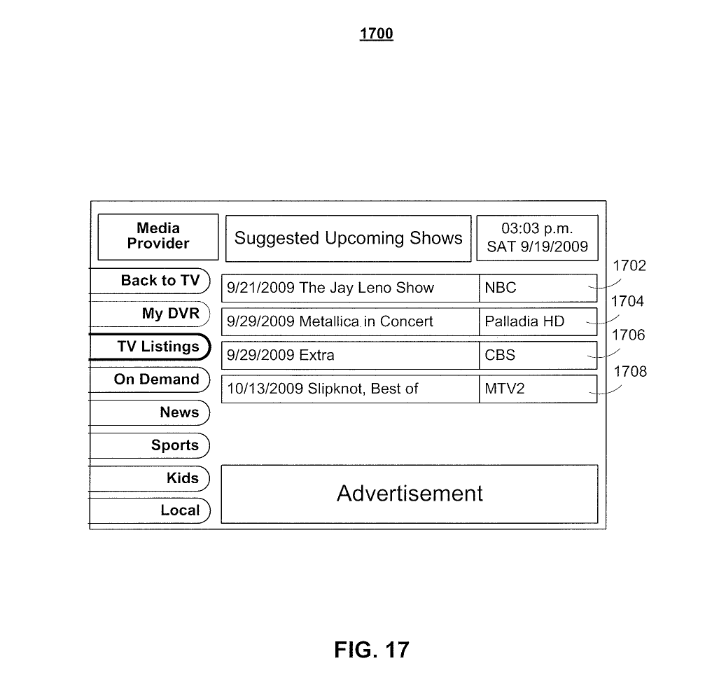

FIG. 17 is an illustrative display of a scheduled upcoming shows screen in accordance with one embodiment of the invention. In one embodiment, screen 1700 is used to show a list of suggested upcoming shows, items 1702, 1704, 1706, 1708, in which artists in the list of favored artists is scheduled to perform. For instance, a user may browse the list of suggested upcoming shows to determine whether he/she should record a particular show. The user may not like The Jay Leno Show, but enjoys watching Metallica in Concert. He/she may then select Metallica in Concert (i.e., item 1704) and schedule a program reminder, or a recording. Program reminders, or any other media asset actions may be scheduled using system 600 as a default action. For instance, all suggested upcoming shows may be scheduled for recording by default. Suggested upcoming shows may also have program reminders scheduled by default.

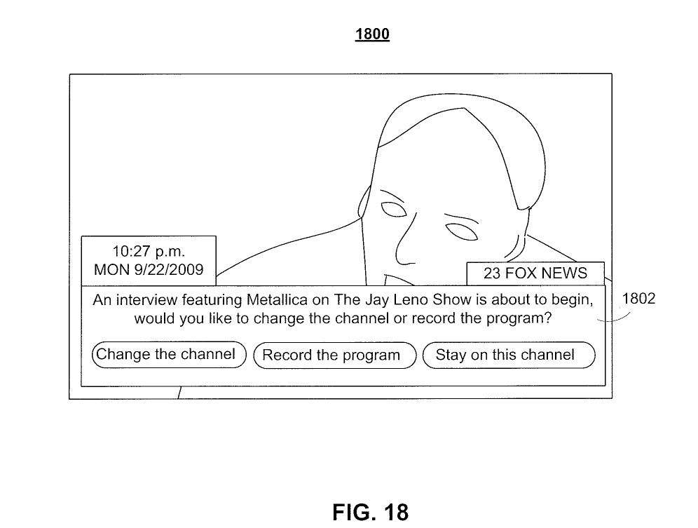

FIG. 18 is an illustrative display of a program reminder in accordance with one embodiment of the invention. In this embodiment, Metallica is in the list of favored artists. Information about a Metallica performance is obtained, and The Jay Leno Show has been identified as the media asset. Program reminder has been scheduled and appears as pop up 1802 on screen 1800 while a video is being watched. Pop up 1802 identifies the performance and the performing artist (e.g., “An interview featuring Metallica”), the name of the media asset (e.g., “The Jay Leno Show”), and a prompt for the user to determine which action to take. Actions available to the user includes changing the channel, recording the program, or staying on the channel. At least one of the options may be provided to the user. Other options may also be provided, such as ignoring the program reminder, asking to never be reminded about the program, or asking to be reminded later.

FIG. 19 is an illustrative flow diagram for scheduling for recording a media asset in accordance with an embodiment of the invention. At step 1902 of method 1900, a list of artists that are favored by a user is obtained. For example, the list of artists that are favored by a user may be obtained from user input on a website, or on an interactive media guidance application, or inferred from a user's interactions with a website and/or an interactive media guidance application, or any applications. In certain embodiments, list of artists may be obtained or extracted from user input. An example of a list of artists is obtained is discussed in relation to FIG. 7.

At step 1904, information is obtained from a website by parsing textual data of a webpage of a website to extract schedule and non-schedule information associated with a performance of an artist, where the extracted information indicates that one of the artists in the list is scheduled to perform during a particular time. Extracting information from the website may include extracting/obtaining information about the performance by parsing the textual data on a webpage of the website. The extracted information may include schedule and/or non-schedule information. The extracted information from the website indicates that one of the artists in the list (e.g., Metallica) is scheduled to perform during a particular time. For instance, a script may use regular expressions to search for a textual pattern that includes the name of a broadcaster and numbers that indicates time (i.e., schedule information about a performance). In another instance, a script may search for embedded structured data, such as XML data, located in or linked from an HTML file to extract information about performances. An example of extracted information from the website and the method for performing the same are discussed in relation to FIGS. 8-10. In particular, FIGS. 8-9 are examples of a website that includes schedule and non-schedule information about performance(s). FIG. 10 is an example of the extracted information from the website shown in FIG. 8.

At step 1906, a media asset associated with the scheduled performance is identified based on the extracted information. After extracting information from the website about a scheduled performance, the information is used to identify the media asset associated with the scheduled performance. For example, if processing server 608 extracts information indicating that Metallica is going to perform at 10 pm on NBC on Sep. 28, 2009, the processing server 608 then uses the extracted information to search in database 650 of media guidance data source 610 for the media asset associated with the scheduled performance. Further details regarding step 1906 is discussed in relation to FIGS. 6 and 11. In particular, FIG. 11 discusses the data structure of the identified media asset.

At step 1908, the identified media asset is scheduled for recording. In some embodiments, a message may be sent to user equipment 602 to schedule the media asset for recording, such as one shown in and discussed in relation to FIG. 12. Scheduling for recording, or other media asset actions are discussed in relation to FIGS. 13-18.

In certain embodiments, the method returns to step 1904 to continue to extract further information from websites by way of parsing webpages. In some embodiments, the method returns to step 1902 to continue to obtain a list of artists that are favored by a user.

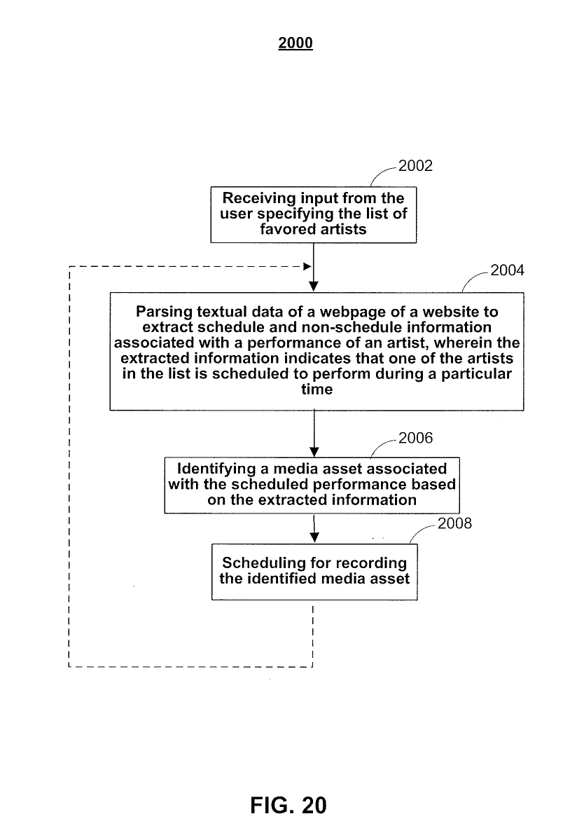

FIG. 20 is an illustrative flow diagram for scheduling for recording a media asset in accordance with an embodiment of the invention. At step 2002 of method 2000, input from the user specifying the list of favored artists is received. For example, textual input may be received via an interactive media guidance application. Receiving textual input is discussed in relation to FIG. 7. Steps 2004, 2006, 2008 are discussed in relation to steps 1904, 1906, and 1908 respectively.

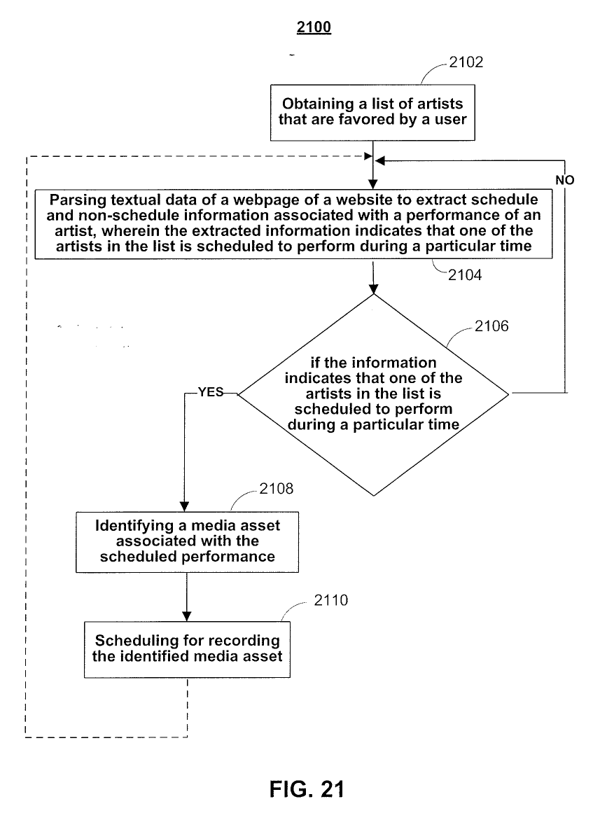

FIG. 21 is an illustrative flow diagram for scheduling for recording a media asset in accordance with an embodiment of the invention. Step 2102 is discussed in relation to 1902. Alternatively, step 2002 may be performed in place of step 2102. Method 2100 allows system 600 to extract information from at least one website by parsing a webpage (step 2104), and checking to see if the information indicates that one of the artists in the list is scheduled to perform during a particular time (step 2106). If the information pertains to one of the artists (e.g., information indicates that one of the artists in the list is scheduled to perform during a particular time), then method 2100 proceeds to steps 2108 and 2110. If the information does not pertain to one of the artists, then method 2100 returns to step 2104 to extract further information from at least one website. In alternative embodiments, method 2100 returns to step 2102 to continue to build the list of artists that are favored by a user. Steps 2108 and 2100 are discussed in relation to 1906 and 1908.

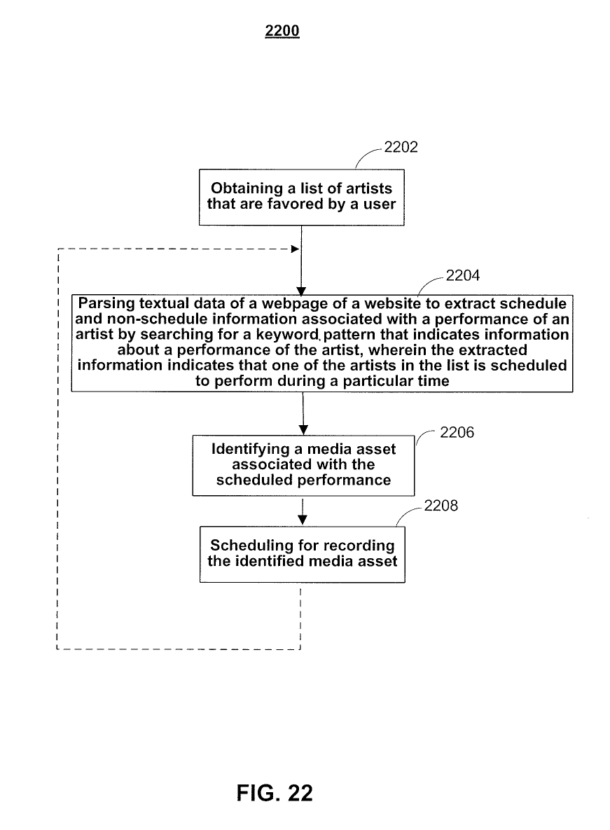

FIG. 22 is an illustrative flow diagram for scheduling for recording a media asset in accordance with an embodiment of the invention. Method 2200 describes another embodiment similar to method 1900 of FIG. 19, where parsing textual data from a webpage of a website (step 1904) includes searching for a keyword pattern that indicates information about a scheduled performance (step 2204). Systems and methods related to parsing and/or extracting schedule and non-schedule information are discussed in relation to FIG. 10. For example, a PERL script that parses HTML files may be used to extract information from a website regarding performances by using regular expressions to find keywords such as “appearance”, “interview”, etc. Steps 2202, 2206, and 2208 are discussed in relation to 1902, 1906, and 1908.

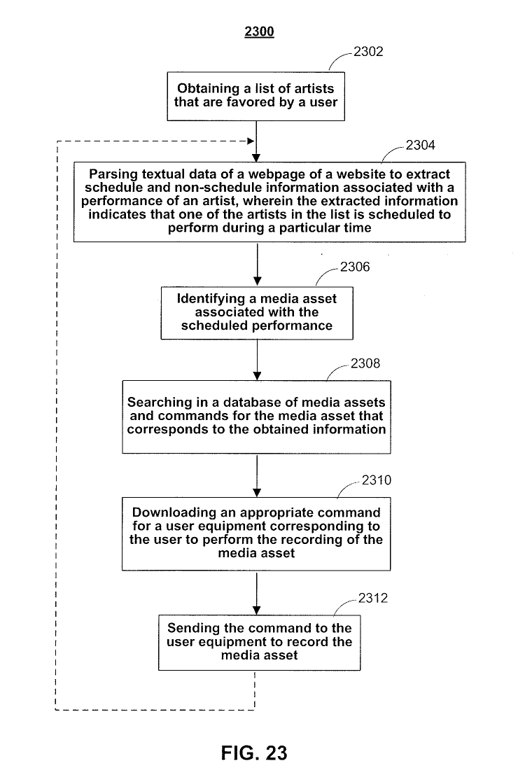

FIG. 23 is an illustrative flow diagram for scheduling for recording a media asset in accordance with an embodiment of the invention. Method 2300 describes another embodiment similar to method 1900 of FIG. 19, where scheduling for recording the identified media asset (step 1908) includes steps 2308, 2310, and 2312 of FIG. 23. Steps 2302, 2304, and 2306 are discussed in relation to 1902, 1904, and 1906 of FIG. 19.

After the media asset has been identified (step 2306), method 2300 proceeds to step 2308 to search in a schedule database of media assets and commands for the media asset that corresponds to the extracted information (step 2308), downloads an appropriate command for a user equipment corresponding to the user to perform the recording of the media asset (step 2310), and sends the command to the user equipment to record the media asset (step 2312).

Regarding step 2308, the database of media assets and commands may be a collection of media assets and recording commands associated with the media assets in the database. Searching of the database (e.g., the searching function) may be implemented as a database query, or a look up in a hash table. The database of media assets and commands may be stored in media guidance data source 610.

Regarding step 2310, processing server 608 may download from media guidance data source 610 an appropriate command for user equipment 602 corresponding to the user to perform the recording of the media asset. For instance, processing server 608 may download a “schedule recording” command from media guidance data source 610. Commands may be user equipment-specific, or may be application-specific (e.g., software specific).

Regarding step 2312, processing server 608 may send the command to user equipment 602 to record the media asset. For example, processing server 608 may send the “schedule recording” command to a set top box in the user's home to record “Top Gear” television series on channel 856. In another example, processing server 608 may send a “set a program reminder” command a mobile phone to remind the user of the television program series “Dirty Jobs with Mike Rowe” on the Discovery Channel.

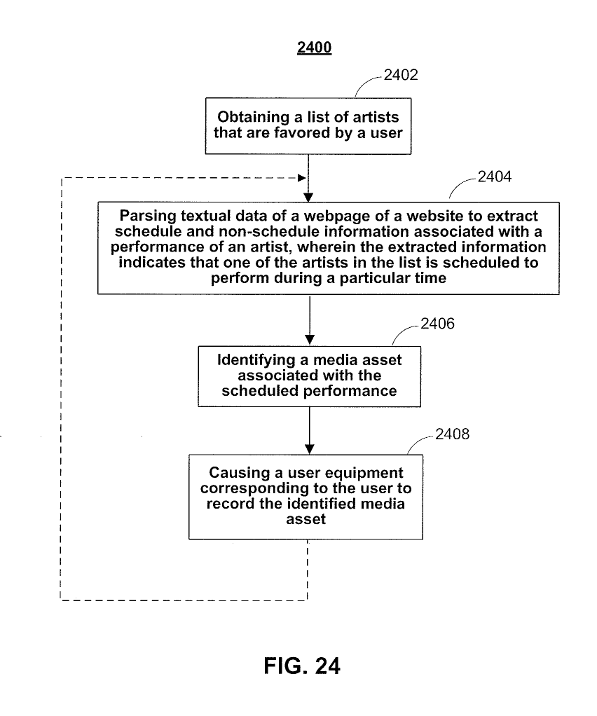

FIG. 24 is an illustrative flow diagram for scheduling for recording a media asset in accordance with an embodiment of the invention. Method 2400 describes another embodiment similar to method 1900 of FIG. 19, where scheduling for recording the identified media asset (step 1908) includes causing a user equipment corresponding to the user to record the identified media asset (step 2408). Steps 2402, 2404, and 2406 are discussed in relation to steps 1902, 1904, and 1906 of FIG. 19.

At step 2408, processing server 608 may cause user equipment 602 to record the identified media asset. An example of causing user equipment 602 to record the identified media asset is by sending a message to user equipment. An example of a message, or other ways to cause the user equipment 602 to record the identified media asset is discussed at length in relation to FIG. 11. For instance, a remote access command transmitted over the Internet to cause the user equipment 602 to record the identified media asset.

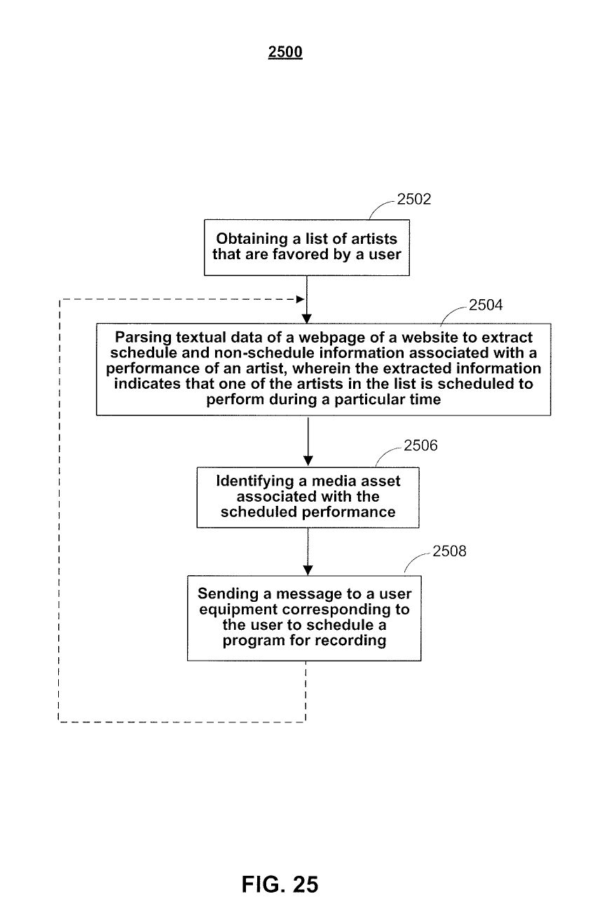

FIG. 25 is an illustrative flow diagram for scheduling for recording a media asset in accordance with an embodiment of the invention. Method 2500 describes another embodiment similar to method 1900 of FIG. 19, where scheduling for recording the identified media asset (step 1908) includes sending a message to a user equipment corresponding to the user (step 2508). Steps 2502, 2504, and 2506 are discussed in relation to steps 1902, 1904, and 1906 of FIG. 19.

Regarding step 2508, processing server 608 may send a message, such as one shown in FIG. 12, to user equipment 602 corresponding to the user. For example, processing server 608 may send an SMS text message to a mobile phone to record an audio podcast scheduled to release on Sep. 4, 2009 at midnight.

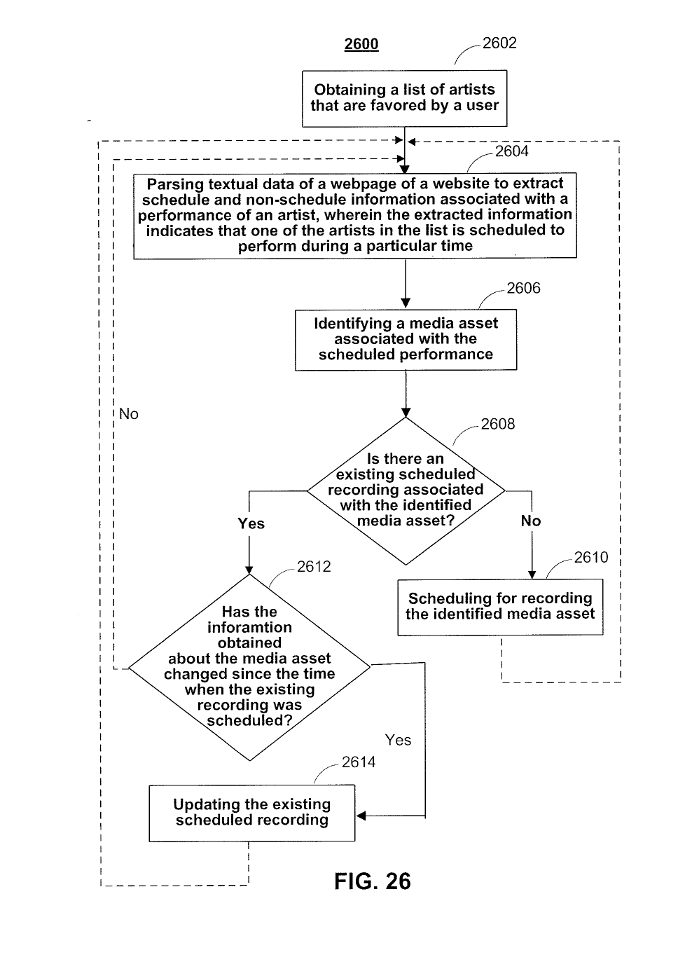

FIG. 26 is an illustrative flow diagram for scheduling for recording a media asset in accordance with an embodiment of the invention. Method 2600 relates to updating an existing scheduled recording if the information about the performance has changed. Step 2602, 2604 and 2606 are discussed in relation to 1902, 1904, and 1906 of FIG. 19. Once a media asset associated with the scheduled performance has been identified (step 2606), method 2600 proceed to determine whether there is an existing scheduled recording associated with the identified media asset.

If there was an existing scheduled recording, method 2600 determines whether the extracted information about the media asset has changed since the time when the existing recording was scheduled (step 2612). The determination in step 2612 may be done by checking the time stamp, such as the time stamp fields, as discussed in relation to FIGS. 10-12.

If the information has changed, method 2600 proceeds to step 2614 to update the existing scheduled recording. For instance, processing server 608 may send a message to user equipment to edit the scheduled recording of “House”. The message may resemble one shown in FIG. 13. If the information has not changed, method 2600 returns to step 2604 to continue extracting further information from websites.

If there does not exist a scheduled recording, method 2600 proceeds to step 2610 to scheduled for recording the identified media asset. Step 2610 is performed in a similar fashion as step 1908 in FIG. 19.

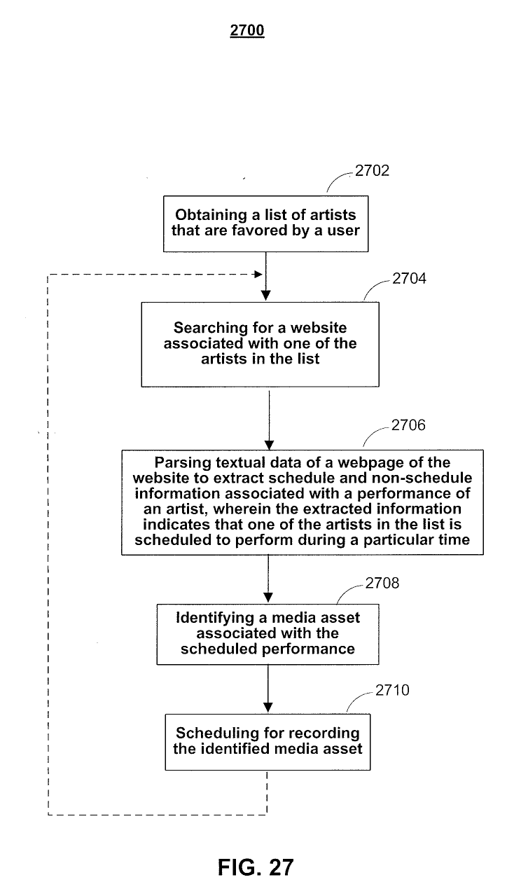

FIG. 27 is an illustrative flow diagram for scheduling for recording a media asset in accordance with an embodiment of the invention. Method 2700 relates to method 1900 in FIG. 27. Step 2702, 2708 and 2710 are discussed in relation to steps 1902, 1906, and 1908 of FIG. 19. After obtaining a list of artists that are favored by a user (step 2702), method 2700 proceeds to search for a website associated with one of the artists in the list (step 2704). Step 2704 may be performed by processing server 608. In one embodiment, processing server 608 may search among a known list of websites for website(s) that relates to the artist. In another embodiment, processing server 608 may use a search engine, such as Google.com, to look for the website associated with one of the artists in the list.

After step 2704, method 2700 proceeds to step 2706, where information is extracted from the associated website. The information indicates that the one of the artists in the list is scheduled to perform during a particular time. Example of the information extracted is shown in and discussed in relation to FIG. 10.

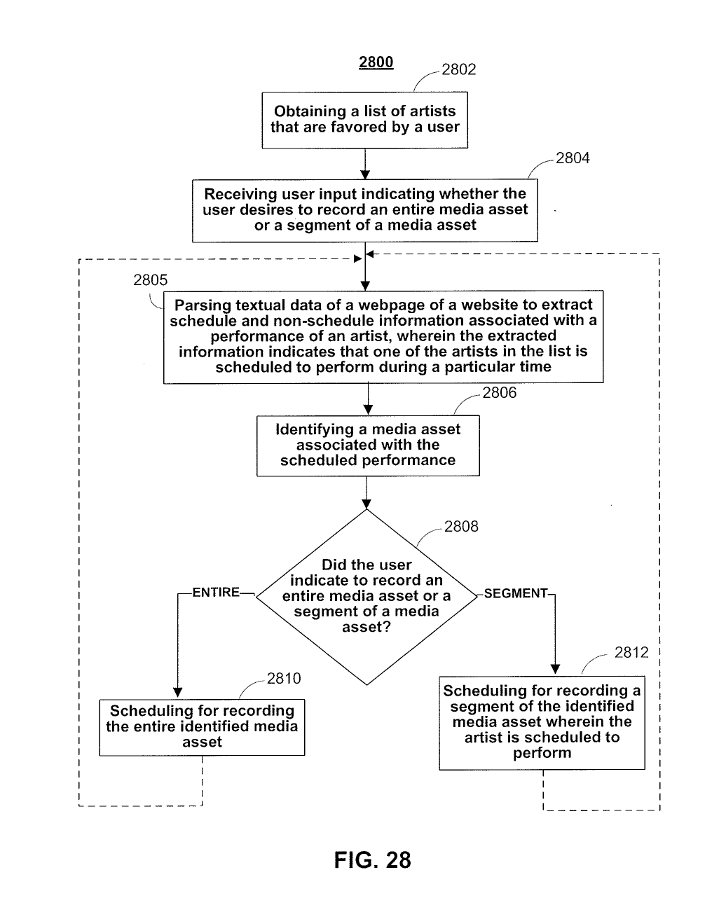

FIG. 28 is an illustrative flow diagram for scheduling for recording a media asset in accordance with an embodiment of the invention. Method 2800 relates to a method that allows a user to select whether he/she wishes to record an entire media asset, or only a segment of the media asset in which the artist appears. Step 2802, 2805, 2806 and 2610 are discussed in relation to 1902, 1904, 1906 and 1908 of FIG. 19.

At step 2804, user input indicating whether the user desires to record an entire media asset or a segment of a media asset. An example of an interface that requests for this user input is shown in and discussed in relation to FIG. 7. For example, a user may indicate that he/she would like to record a segment of the show if any one of the rock bands in the list of favored rock bands is scheduled to appear.

At step 2808, the system checks to see whether the user had indicated to record an entire media asset or a segment of a media asset. If the user has chosen to record an entire media asset, method 2800 proceeds to step 2810 to schedule for recording the entire media asset. For example, even though the band Metallica is only appearing on a segment of The Jay Leno show, the entire episode airing of The Jay Leno Show is recorded.

If the user has chosen to record only the segment of the media asset in which the artist is schedule to perform, then method 2800 proceeds to step 2812 to schedule for recording a segment of the identified media asset wherein the artist is scheduled to perform. For example, if a website has indicated that Metallica is scheduled to perform during three segments of Saturday Night Live, only the three segments of Saturday Night Live would be recorded. Methods for recording an entire media asset or a segment of a program is discussed in relation to FIG. 12.

It should be understood, that the above steps of the flow diagrams of FIGS. 19-28 may be executed or performed in any order or sequence no limited to the order and sequence shown and described in the figures. Also, some of the above steps of the flow diagrams of FIGS. 19-28 may be executed or performed substantially simultaneously where appropriate or in parallel to reduce latency and processing times.

The above described embodiments of the present invention are presented for purposes of illustration and not of limitation, and the present invention is limited only by the claims which follow.

1. A method for recording a media asset, the method comprising:
obtaining a list of artists that are favored by a user;
parsing textual data of a webpage of a website to extract schedule and non-schedule information associated with a performance of an artist, wherein the extracted information indicates that one of the artists in the list is scheduled to perform during a particular time;
identifying a media asset associated with the scheduled performance of the artist based on the extracted information; and
scheduling for recording the identified media asset.

2. The method in claim 1, wherein obtaining the list of favored artists comprises receiving input from the user specifying the list of favored artists.

3. The method in claim 2, wherein the user input comprises textual input from the user that identifies the list of favored artists.

4. The method in claim 2, wherein the user input comprises user selection of the list of favored artists from a database of artists.

5. The method in claim 1, wherein the list of favored artists comprises at least one of: an actor, actress, a band, a singer, a celebrity, an entertainer, public figure, and any combination thereof.

6. The method in claim 1, wherein a performance of the artist comprises at least one of: acting, speaking, dancing, playing music, and appearing.

7. The method in claim 1, wherein parsing the textual data of the webpage of the website comprises searching for a keyword pattern that indicates information about the performance of the artist.

8. The method in claim 1, wherein the schedule information comprises channel information, the start time of the performance.

9. The method in claim 1, wherein non-schedule information comprises at least one of: title of the media asset associated with performance and identity of the artist performing during the particular time.

10. The method in claim 1, wherein the particular time is the start time of the media asset.

11. The method in claim 1, wherein the particular time corresponds to a time interval within the media asset during which the artist starts performing.

12. The method in claim 1, wherein scheduling for recording the identified media asset comprises:
searching in a database of media assets and commands for the media asset that corresponds to the obtained information;
downloading an appropriate command for a user equipment corresponding to the user to perform the recording of the media asset; and
sending the command to the user equipment to record the identified media asset.

13. The method in claim 1, wherein scheduling for recording the identified media asset comprises causing a user equipment corresponding to the user to record the identified media asset.

14. The method in claim 1, wherein scheduling for recording the identified media asset comprises sending a message to a user equipment corresponding to the user to record the identified media asset.

15. The method in claim 1, wherein scheduling for recording the identified media asset comprises:
detecting a change in the information on the website;
updating an existing scheduled recording, in response to detecting the change, when a change in the extracted information is detected since a time when the existing recording was scheduled.

16. The method of claim 1, wherein obtaining information from the website comprises:
searching for a website associated with one of the artists in the list.

17. A system for recording a media asset, the system comprising:
a processor configured to:
obtain a list of artists that are favored by a user;
parse textual data of a webpage of a website to extract schedule and non-schedule information associated with a performance of an artist, wherein the extracted information indicates that one of the artists in the list is scheduled to perform during a particular time;
identify a media asset associated with the scheduled performance of the artist based on the extracted information; and
schedule for recording the identified media asset.

18. The system in claim 17, wherein obtaining the list of favored artists comprises receiving input from the user specifying the list of favored artists.

19. The system in claim 17, wherein the user input comprises textual input from the user that identifies the list of favored artists.

20. The system in claim 17, wherein the user input comprises user selection of the list of favored artists from a database of artists.

21. The system in claim 17, wherein the list of favored artists comprises at least one of: an actor, actress, a band, a singer, a celebrity, an entertainer, public figure, and any combination thereof.

22. The system in claim 17, wherein a performance of the artist comprises at least one of: acting, speaking, dancing, playing music, and appearing.

23. The system in claim 17, wherein parsing the textual data of the webpage of the website comprises searching for a keyword pattern that indicates information about the performance of the artist.

24. The system in claim 17, wherein the schedule information comprises channel information, the start time of the performance.

25. The system in claim 17, wherein non-schedule information comprises at least one of: title of the media asset associated with performance and identity of the artist performing during the particular time.

26. The system in claim 17, wherein the particular time is the start time of the media asset.

27. The system in claim 17, wherein the particular time corresponds to a time interval within the media asset during which the artist starts performing.

28. The system in claim 17, wherein scheduling for recording the identified media asset comprises:
searching in a database of media assets and commands for the media asset that corresponds to the obtained information;
downloading an appropriate command for a user equipment corresponding to the user to perform the recording of the media asset; and
sending the command to the user equipment to record the identified media asset.

29. The system in claim 17, wherein scheduling for recording the identified media asset comprises causing a user equipment corresponding to the user to record the identified media asset.

30. The system in claim 17, wherein scheduling for recording the identified media asset comprises sending a message to a user equipment corresponding to the user to record the identified media asset.

31. The system in claim 17, wherein scheduling for recording the identified media asset comprises:
detecting a change in the information on the website;
updating an existing scheduled recording, in response to detecting the change, when a change in the extracted information is detected since a time when the existing recording was scheduled.

32. The system of claim 17, wherein obtaining information from the website comprises:
searching for a website associated with one of the artists in the list.

33.-48. (canceled)

49. A method for recording a media asset, the method comprising:
obtaining a list of entities that are favored by a user, wherein entities comprise any one of: company, organization, product, category of products, and brand name;
parsing textual data of a webpage of a website to extract schedule and non-schedule information of a related media asset, wherein the extracted information indicates that one of the entities in the list is related to the content of the media asset scheduled for broadcast at a particular time;
identifying a media asset related with the entity based on the extracted information; and
scheduling for recording the identified media asset that includes the content associated with the entity.

50. The method in claim 49, wherein parsing the textual data of the webpage of the website comprises searching for a keyword pattern that indicates schedule and non-schedule information about the related media asset.

51. The method in claim 49, wherein the schedule information comprises channel information, the start time of the media asset.

52. The method in claim 49, wherein non-schedule information comprises at least one of: name of the media asset, and description of the content included in the media asset.

53. A system for recording a media asset, the system comprising:
a processor configured to:
obtain a list of entities that are favored by a user, wherein entities comprise any one of: company, organization, product, category of products, and brand name;
parse textual data of a webpage of a website to extract schedule and non-schedule information of a related media asset, wherein the extracted information indicates that one of the entities in the list is related to the content of the media asset scheduled for broadcast at a particular time;
identify a media asset related with the entity based on the extracted information; and
schedule for recording the identified media asset that includes the content associated with the entity.

54. The system in claim 53, wherein parsing the textual data of the webpage of the website comprises searching for a keyword pattern that indicates schedule and non-schedule information about the related media asset.

55. The system in claim 53, wherein the schedule information comprises channel information, the start time of the media asset.

56. The system in claim 53, wherein non-schedule information comprises at least one of: name of the media asset, and description of the content included in the media asset.

57.-60. (canceled)

61. A method for recording a media asset, the method comprising:
obtaining a list of artists that are favored by a user;
receiving an update from a web server, wherein:
the web server includes a web site; and
the received update includes schedule and non-schedule information which indicate that one of the artists in the list is scheduled to perform during a particular time different from a previously scheduled time;
identifying a media asset associated with the scheduled performance of the artist based on the received information;
determining whether the media asset associated with the scheduled performance has been scheduled for recording at the previously scheduled time; and
updating the existing scheduled recording with the particular time, in response to receiving the update from the web server, when the media asset has been scheduled for recording at the previously scheduled time.

62. The method in claim 61, wherein receiving the update from the web server comprises receiving the schedule and non-schedule information via an application programming interface.

63. The method in claim 61, wherein receiving the update from the web server comprises receiving a notification from the web server that information about a performance is available.

64. The method in claim 63, wherein the notification includes the location in which the information about the performance is stored.

65. A system for recording a media asset, the system comprising:
a processor configured to:
obtain a list of artists that are favored by a user;
receive an update from a web server, wherein:
the web server includes a web site; and
the received update includes schedule and non-schedule information which indicate that one of the artists in the list is scheduled to perform during a particular time different from a previously scheduled time;
identify a media asset associated with the scheduled performance of the artist based on the received information;
determine whether the media asset associated with the scheduled performance has been scheduled for recording at the previously scheduled time; and
update the existing scheduled recording with the particular time, in response to receiving the update from the web server, when the media asset has been scheduled for recording at the previously scheduled time.

66. The system in claim 65, wherein receiving the update from the web server comprises receiving the schedule and non-schedule information via an application programming interface.

67. The system in claim 65, wherein receiving the update from the web server comprises receiving a notification from the web server that information about a performance is available.

68. The system in claim 67, wherein the notification includes the location in which the information about the performance is stored.

69.-72. (canceled)
